(19) United States
(12) Patent Application Publication
(10) Pub. No.: US 2025/0367631 A1
(43) Pub. Date: Dec. 4, 2025

(54) TWO PHASE FLOWS FOR REACTIONS AND SEPARATIONS

(71) Applicants: Montgomery Baker-Fales, Missouri City, TX (US); Dionisios G. Vlachos, Newark, DE (US)

(72) Inventors: Montgomery Baker-Fales, Missouri City, TX (US); Dionisios G. Vlachos, Newark, DE (US)

(73) Assignee: University of Delaware, Newark, DE (US)

(21) Appl. No.: 18/675,478

(22) Filed: May 28, 2024

(51) Int. Cl. B01J 19/00; B01J 19/08; B01J 19/24

(52) U.S. Cl. CPC B01J 19/0093; B01J 19/088; B01J 19/249; B01J 2219/00783; B01J 2219/00831; B01J 2219/00833; B01J 2219/00853; B01J 2219/0086; B01J 2219/00894; B01J 2219/0884; B01J 2219/0894; B01J 2219/2488; B01J 2219/249

(57) ABSTRACT

Disclosed herein is a method for designing a liquid-liquid biphasic micro-fluidic flow channel reactor for continuous extraction or reactive extraction, where chemistry happens in one phase and the product is removed to the other. The method comprises developing random forest and symbolic genetic regression machine learning (ML) models to predict flow patterns and the mass transfer rate, respectively, using a combination of experimental and computational fluid dynamics (CFD) data and literature-mined data while accounting for the effects of solvent properties and channel diameter. This enables rapid prediction for efficient scale-up of microchannels to millichannels. To minimize the number of CFD simulations and maximize model accuracy, the method comprises using active learning techniques.

### STATEMENT REGARDING FEDERALLY SPONSORED RESEARCH

This invention was made with government support under Grant No. DE-EE0007888-7.6 awarded by the Department of Energy's Office of Energy Efficient and Renewable Energy's Advanced Manufacturing Office. The government has certain rights in the invention.

### BACKGROUND OF THE INVENTION

Recent developments in microfluidic technology have enabled process intensification and miniaturization of chemical processes. Microstructured devices usually consist of channels with diameters of less than 1 mm. Their small characteristic length scale enables large surface-to-volume ratios. As a result, the heat and mass transfer rates surpass those of traditional large-scale batch or continuous flow reactors. Fast mass transfer and laminar flow allow for precise control over residence time. These characteristics lead to significant advantages in nitration, polymerization, and rearrangement reactions.

Liquid-liquid biphasic microchannels exhibit various flow patterns that impact transport rates. These can be engineered by changing solvents (density, viscosity, and surface tension), the fraction of each phase, the micromixer where the streams intersect (T-junction, Y-junction, etc.), the wall hydrophilicity, and the channel diameter, length, and geometry. This tunability can significantly improve the reactor throughput. The most common patterns are segmented (slugs and droplets) and parallel flow. In the former, the two liquids form alternating segments where the wall-wetting fluid (continuous phase) usually forms a thin film around the non-wetting fluid (dispersed phase). In the latter, one fluid flows alongside the other. Parallel flow has found application in liquid-liquid extraction and characterization of various products, such as metals, metal complexes, and DNA, achieving high extraction efficiency within reduced contact times. Segmented flow, on the other hand, keeps the dispersed phase away from the wall, and the strong inner recirculation enhances mass transfer, producing well-controlled nanoparticles.

While microchannels offer advantages, they possess low throughput and a relatively higher-pressure drop. Scaling out to a suitable throughput needs many channels, resulting in more wall material for construction. Known methods include scaling-up the basic unit until performance starts decreasing, and then increasing the number of units by placing several channels in parallel. Determining the ‘critical size’ above which the microscale advantages diminish has been found to be helpful.

Traditionally, dimensionless numbers, such as the Ca (Capillary number), Re (Reynolds number), We (Weber number), and Oh (Ohnesorge number) of both phases are used to predict flow patterns. However, these flow maps do not hold as solvents and the diameter change. Desir et al. used a decision tree model to predict flow patterns for multiple solvents using six features and achieved >95% accuracy. Desir, P.; Chen, T.-Y.; Bracconi, M.; Saha, B.; Maestri, M.; Vlachos, D. G. “Experiments and computations of microfluidic liquid-liquid flow patterns.” Reaction Chemistry & Engineering 2020, 5 (1), 39-50. Wang et al. investigated liquid-liquid mass transfer for multiple diameters and lengths and proposed a correlation for the mass transfer rate in the mm scale. Wang, X.; Wang, Y.; Li, F.; Li, L.; Ge, X.; Zhang, S.; Qiu, T. “Scale-up of microreactor: Effects of hydrodynamic diameter on liquid-liquid flow and mass transfer.” Chemical Engineering Science 2020, 226, 115838. Chen et al. studied the HMF liquid-liquid extraction for multiple solvents experimentally and computationally. Chen, T.-Y.; Desir, P.; Bracconi, M.; Saha, B.; Maestri, M.; Vlachos, D. G. “Liquid-Liquid Microfluidic Flows for Ultrafast 5-Hydroxymethyl Furfural Extraction.” Industrial & Engineering Chemistry Research 2021, 60 (9), 3723-3735. Other studies have also tried to predict the impact of diameter or length, but solvent effects and uncertainty quantification associated with the data have been lacking.

Liquid-liquid microchannels have high mass transfer rates but low throughput. To increase productivity, they can be scaled up by increasing the diameter. Therefore, predicting flow patterns and mass transfer rates while accounting for solvent effects as the diameter varies is crucial; however, this topic is currently lacking in the literature. Hence, there is a need for a new method for designing a liquid-liquid biphasic micro-fluidic flow channel reactor, with increased throughput, that takes into account the solvent effects as the diameter is increased to increase the throughput.

### SUMMARY OF THE INVENTION

One aspect of the invention relates to a method that includes developing random forest and symbolic genetic regression machine learning (ML) models to predict flow patterns and the mass transfer rate, respectively, using a combination of experimental and computational fluid dynamics (CFD) data and literature-mined data while accounting for the effects of solvent properties and channel diameter. This enables rapid prediction for efficient scale-up of microchannels to millichannels. To minimize the number of CFD simulations and maximize model accuracy, active learning techniques were employed. Furthermore, the uncertainty of the ML models built on hybrid data were quantified.

Another aspect of the invention relates to a method for designing a second liquid-liquid biphasic micro-fluidic flow channel reactor, the method comprising the steps of providing a plurality of experimental datasets as a function of an organic solvent and a first inner diameter of a first liquid-liquid biphasic micro-fluidic flow channel reactor, wherein the first liquid-liquid biphasic micro-fluidic flow channel reactor comprises a first inlet channel for a first stream comprising an aqueous phase comprising at least a first compound dispersed in water and a second inlet channel for a second stream comprising an organic phase comprising an organic solvent operative to extract the first compound from the aqueous phase, the first stream and the second stream configured to intersect in a micromixer region connected to an outlet channel for outputting a third stream of biphasic fluid in which a mass percentage of the first compound transfers into the organic solvent. The method also comprises providing a plurality of computational fluid dynamics (CFD) datasets as a function of the aqueous phase, the organic phase, and an inner diameter of the first liquid-liquid biphasic micro-fluidic flow channel reactor; and developing at least one active machine learning (ML) model to predict biphasic flow patterns and mass transfer rate in the micro-fluidic flow channel, wherein the at least one active ML model uses a training subset of the plurality of experimental datasets and a training subset of the plurality of CFD datasets. The method further comprises testing the efficacy of the at least one active ML model using a remaining testing subset of the plurality of experimental datasets and a remaining testing subset of the plurality of CFD datasets not used for the at least one active ML model; generating a mathematical expression for determining a maximum mass transfer rate as a function of inner diameter and length of the outlet channel, using the at least one active ML model; and designing a second liquid-liquid biphasic micro-fluidic flow channel reactor, having the same micromixer configuration and the same organic and aqueous phases as that of the first liquid-liquid biphasic micro-fluidic flow channel reactor, using the mathematical expression, wherein a second inner diameter of the second liquid-liquid biphasic micro-fluidic flow channel reactor is greater than the first inner diameter, whereby a second throughput of second liquid-liquid biphasic micro-fluidic flow channel reactor is greater than a first throughput of the first liquid-liquid biphasic micro-fluidic flow channel reactor.

In an embodiment of the method, the organic phase further comprises a second compound dispersed in the organic solvent, and the biphasic fluid comprises a third compound, which is a product of a reaction between the first compound and the second compound.

In another embodiment, the step of providing a plurality of CFD datasets comprises performing principal component analysis (PCA) to identify features, including material properties and dimensionless parameters, for both the aqueous phase and the organic phase that has an impact on the liquid-liquid biphasic micro-fluidic flow channel reactor's behavior. In some embodiments, the features for each of the aqueous phase and the organic phase comprises kinematic viscosity (μ), density (φ, velocity (u), Capillary number (Ca), Reynolds number (Re), Weber number (We), Ohnesorge number (Oh), and Diffusivity (D).

In an embodiment of the method, the step of developing the at least one active ML model comprises using a random forest algorithm to predict biphasic flow patterns. In one embodiment, the biphasic flow patterns are selected from the group consisting of a slug flow, a drop flow, a slug/drop flow, and an irregular flow.

In various embodiments, a response space of the at least one ML model encompasses the predicted biphasic flow patterns and predictors comprises of the features required to represent the biphasic flow patterns for each of the aqueous phase and the organic phase. In some embodiments, the method further comprises performing principal component analysis (PCA) to determine features to represent the mass transfer rate, wherein the features comprise Capillary number (Ca), Schmidt number over the partition coefficient (Sc/K), and the length over the diameter (L/d). In an embodiment, the step of developing the at least one active ML model further comprises using symbolic genetic regression to develop a new functional form of mass transfer using the features identified by PCA to represent mass transfer rate.

In various embodiments, the second liquid-liquid biphasic micro-fluidic flow channel reactor comprises at least one millimeter-sized fluidic flow channel.

In an aspect, the aqueous phase comprises 5-hydroxymethylfurfural (HMF) as the first compound and the method comprises extracting HMF from the aqueous phase to the organic phase. In an embodiment, the organic solvent of the organic phase comprises ethyl acetate, methyl isobutyl ketone, and other larger alcohols and ketones (i.e. effectively including all alcohols and ketones with 3 to 7 carbons, including but not limited to: 2-pentanone, 2-butanone, 4-heptanone, 2-pentanol, 1-butanol, 2-butanol, gamma valerolactone), or combinations thereof.

In a further embodiment, the first and the second liquid-liquid biphasic micro-fluidic flow channel reactor have the micromixer configuration of a T-junction and the biphasic fluid pattern is a slug flow. In yet another embodiment, the method further comprises using symbolic genetic regression to define the mathematical expression as equation (1):

$$log ( {Da}^{′} ) = \frac{α * log ( \frac{S c}{K} ) - β - δ log ( \frac{L}{d} )}{log ( Ca ) + γ} \qquad ( 1 )$$

wherein:

$${Da}^{′} ( {k}_{1} a τ ) = \frac{rate of global transport}{rate of global mass transport} ,$$

Ca is a Capillary number; Ca=(μorg)(uaq)/σ, where μorg is a dynamic viscosity of the organic phase, uaq is the velocity of the aqueous phase, and σ is interfacial tension between the organic and aqueous phase,
Sc=μ/pD=viscous diffusion rate/molecular (mass) diffusion rate, where μ, ρ, and D are the dynamic viscosity, density, and diffusivity,
K is partition coefficient of the first compound in the biphasic fluid,
L is a length and d is an inner diameter of the outlet channel, and
α, β, γ, and δ are regression constants, which are determined from regressing to experimental or computational data or both.

In an embodiment, the aqueous phase comprises (i) fructose and/or glucose and a Brønsted acid-catalyst used for dehydration of fructose and/or glucose to yield the HMF, or (ii) glucose and Lewis and Bronsted acid catalysts for isomerization and dehydration reaction to yield the HMF.

In an aspect of the invention, the method further comprises microwave assisted heating of the biphasic fluid in the outlet channel.

In another aspect, a liquid-liquid biphasic micro-fluidic flow channel reactor comprises a first inlet channel configured to receive a stream of an aqueous phase comprising 5-hydroxymethylfurfural (HMF) and a second inlet channel configured to receive a stream of an organic solvent for extracting HMF from the aqueous phase, the organic solvent selected from the group consisting of: ethyl acetate, 2-pentanol, methyl isobutyl ketone, and a combination thereof, the first inlet channel and second inlet channel intersecting in a micromixer region connected to an outlet channel configured to receive a stream of biphasic fluid comprising the HMF in the aqueous phase and the organic solvent, the reactor configured in conformance with mathematical expression Equation (1) as stated herein above.

In an embodiment of the liquid-liquid biphasic micro-fluidic flow channel reactor, the micromixer has a configuration of a T-junction and the biphasic fluid has slug flow pattern.

In an embodiment of the reactor, the α is in a range of 0.5-20, β is in a range of 0.1-10, γ is in a range of 0.1-10, and σ is in a range of 0.1-5.

In another embodiment, the aqueous phase further comprises (i) fructose and the liquid-liquid biphasic micro-fluidic flow channel reactor converts the fructose to HMF via a Brønsted acid-catalyzed fructose dehydration or (ii) glucose and the liquid-liquid biphasic micro-fluidic flow channel reactor converts the glucose to HMF via a Lewis and Brønsted acid-catalyzed isomerization and dehydration reaction.

Another aspect relates to a method of designing a modular micro- or milli-fluidic flow channel reactor, the method comprising using the method as described herein for determining an optimum inner radius for each flow channel for a product stream and/or a waste stream, wherein the product stream comprises biomass comprising a known feedstock for production of renewable fuels, chemicals, and/or bioplastics, and wherein the waste stream comprises food waste, agricultural waste, and/or forestry waste.

### BRIEF DESCRIPTION OF THE DRAWINGS

FIG. 1: A flowchart for a method for designing a second liquid-liquid biphasic micro-fluidic flow channel reactor according to embodiments of the present invention.

FIG. 2: An exemplary T-junction microchannel geometry built in COMSOL with an aqueous and an organic phase inlet each.

FIG. 3: An exemplary schematic diagram of the experimental setup used for flow visualization and mass transfer rate. Adapted from Desir et al.

FIG. 4: Distribution of flow pattern hybrid data set. (E=experimental data, C=computational data, Pent. =Pentanol).

FIG. 5: Flowchart of the methodology combining computational and experimental data (N_{comp}, Nₑₓₚ are the number of points sampled from the normal distribution of computational and experimental datasets; respectively).

FIG. 6: Impact of the number of samples from the normal distribution on the accuracy of the model.

FIG. 7: Power law model regression (Da=Damköhler (I): Damköhler (II), d=diameter).

FIG. 8: Experimental flow patterns: (a) Annular flow with q=10 ml/min, d=1.6 mm, org:aq=3:1, 2-pentanol. (b) Slug/drop flow with q=8 ml/min, d=1.6 mm, org:aq=3:1, 2-pentanol. (c) Drop flow with q=4 ml/min, d=1.6 mm, org:aq=1:1, MIBK. (d) Slug flow with q=5 ml/min, d=1.6 mm, org:aq=3:1, MIBK.

FIG. 9: Confusion matrix for various cases. (a) d=0.5 mm, L=100 mm, u=0.1-10 ml/min, EtAc & water, (b) d=1.6 mm, L=100 mm, u=0.1-10 ml/min, 2-pentanol & water, (c) d=1.6 mm, L=100 mm, u=0.1-10 ml/min, MIBK & water.

FIG. 10: CFD flow patterns with EtAc: (a) slug flow for q=0.2 ml/min, org:aq=1:1, (b) droplet flow for q=2 ml/min, org:aq=1:1, (c) parallel flow for q=5 ml/min, org:aq=1:1, (d) annular flow for q=7 ml/min, org:aq=1:1, (e) irregular flow for q=10 ml/min, d=0.5 mm, org:aq=1:1, (f) slug-drop for q=3 ml/min, org:aq=4:1 (colors reversed). In all cases, d=0.5 mm except for panel d where d=2 mm.

FIG. 11: Maps of flow patterns. (a) Experiments, MIBK, d=1.6 mm, (b) Experiments, 2-pentanol, d=1.6 mm, (c) CFD, EtAc, (d) Experiments, MIBK, d=4.8 mm.

FIG. 12: Feature importance for flow patterns (mean decrease in impurity: capacity of a feature to distinguish unique flow patterns for various features).

FIG. 13: (a) Confusion matrix for the combined flow pattern test dataset (20% hybrid flow pattern dataset, ˜146 data points). (b) Confusion matrix for the random forest model with uncertainty.

FIG. 14: Prediction probability= # of trees predicting the true label/total number of trees for the model without uncertainty.

FIG. 15: Critical total velocity leading to slug flow for different solvent ratios and diameters. The shaded region indicates slug flow for each diameter; to the right of each line, no slug flow exists.

FIG. 16: (a) Symmetric slugs with no deformation (d=0.5 mm and q=0.7 ml/min). (b) Partially symmetric slugs with some deformation (d=2 mm and q=3 ml/min). (c) Deformed slugs with no symmetry (d=5 mm and q=40 ml/min. (d) New flow pattern.

FIG. 17: Experimentally estimated rate of mass transfer for (a) for EtAc, (b) MIBK, and (c) pentanol.

FIG. 18: Parity plot for experimental data vs. CFD (EtAc, d=0.5 mm, L=17 cm, Q=0.2 ml/min-5 ml/min).

FIG. 19: Principal component analysis for the rate of mass transfer features.

FIG. 20: Clustered covariance matrix for features governing the mass transfer rate.

FIG. 21: Parity of experimental and predicted Da′.

FIG. 22: CFD-predicted concentration and rate of mass transfer (d=1 mm, Q=2 ml/min, EtAC).

FIG. 23: Concentration predicted using the equation proposed.

FIG. 24: Mass transfer rate vs. diameter of the channel keeping the residence time constant for various solvents (T=1.93 s, L ranges from 8.2 cm to 0.7 cm) using the machine learning model Eq. 8.

FIG. 25: Changes in mass transfer rate with changes in flow pattern and solvent using CFD.

FIG. 26: Schematic to calculate the uncertainty in the rate of mass transfer.

FIG. 27: Prediction for the rate of mass transfer in parallel and drop flow (EtAc, d=0.5 mm, L=17 cm, Q=1 ml/min−10 ml/min).

FIG. 28: Graph of extraction efficiency as a function of residence time for microwave heating as comparted to conventional heating.

FIG. 29: HMF partitioning sensitivity to temperature for solvents screened via COSMO-RS using data from Wang, infra. Each point represents a single solvent. MW boosting effect is calculated for T_aq−T_int=15° C. The square, diamond, star, and triangle markers indicate MIBK, m-cresol, p-chlorophenol, and indole, respectively. Contours represent iso-constant

$${K}_{HMF}^{MW} .$$

### DETAILED DESCRIPTION OF THE INVENTION

Embodiments of the present invention seek to predict the impact of diameter and solvent on flow patterns and mass transfer rates as the diameter of a liquid-liquid biphasic micro-fluidic flow channel reactor is increased. To achieve this, the inventors conducted experiments and performed computational fluid dynamics (CFD) simulations to account for the effects of solvent and diameter. To reduce the number of CFD simulations, the inventors employed an active learning algorithm. The experimental data generated by the inventors was supplemented with mined literature (prior art) experimental data and these datasets were integrated, considering their uncertainties and fidelity. The inventors constructed an ML model to predict the flow patterns and introduce a new functional form of mass transfer involving dimensionless numbers, utilizing symbolic genetic regression. The method according to various embodiments of the present invention provides a prediction tool for selecting parameters, such as velocity, diameter, and length, to achieve a certain flow pattern and mass transfer coefficient. Additionally, the results provide insights into scale-up and solvent selection for enhanced mass transfer rate.

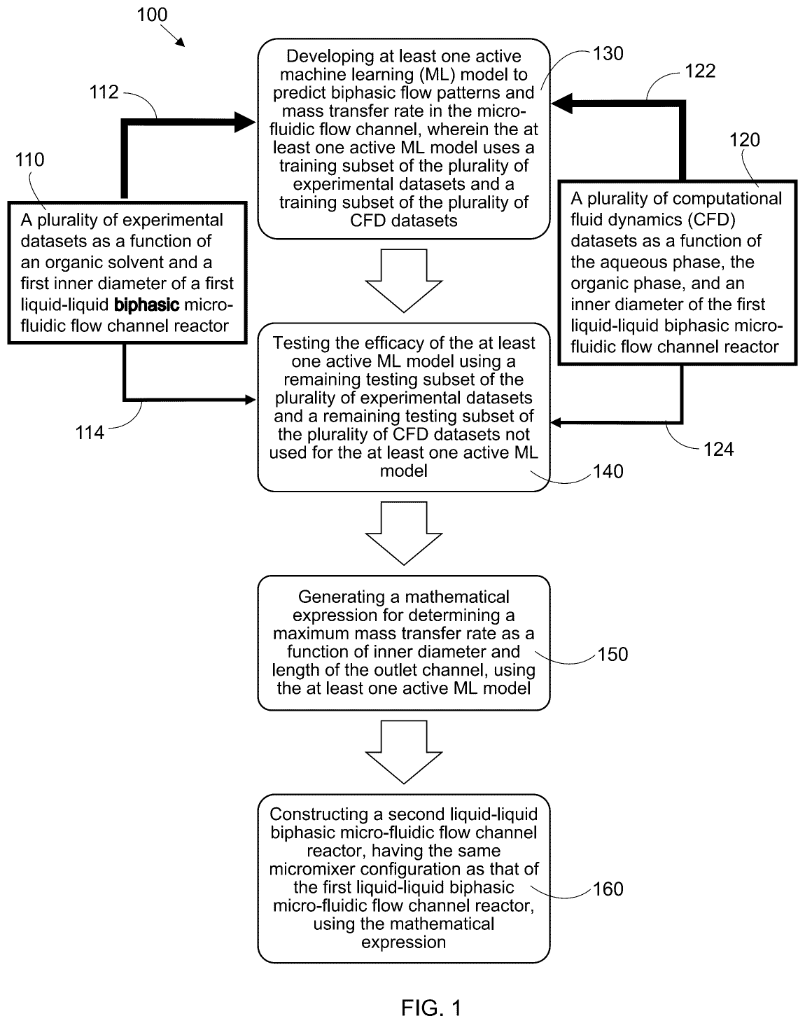

In an aspect of the invention, FIG. 1 shows a flowchart for a method 100 for designing a second liquid-liquid biphasic micro-fluidic flow channel reactor according to embodiments of the present invention. The method 100 comprises a step 110 of providing a plurality of experimental datasets as a function of an organic solvent and a first inner diameter of a first liquid-liquid biphasic micro-fluidic flow channel reactor.

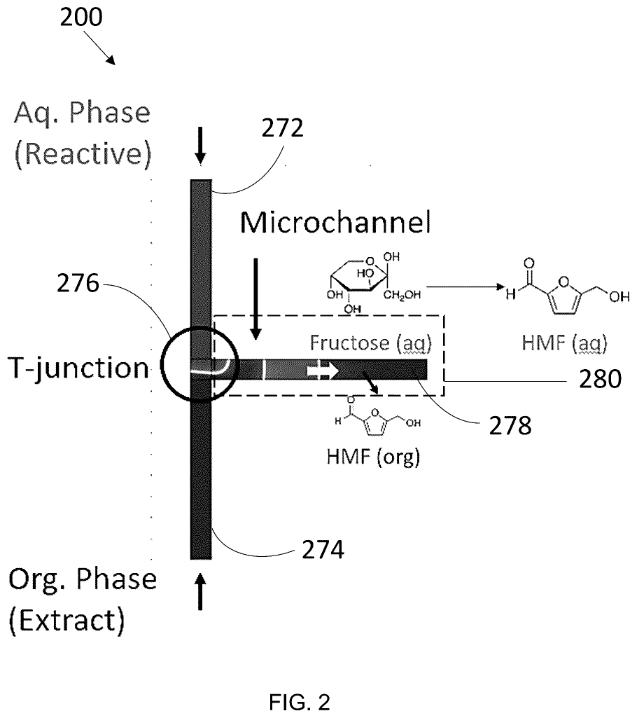

FIG. 2 shows an exemplary schematic illustration of a first liquid-liquid biphasic micro-fluidic flow channel reactor 200, having a T-junction configuration. The first liquid-liquid biphasic micro-fluidic flow channel reactor 200 comprises a first inlet channel 272 for a first stream comprising an aqueous phase comprising at least a first compound dispersed in water and a second inlet channel 274 for a second stream comprising an organic phase comprising an organic solvent operative to extract the first compound from the aqueous phase, the first stream and the second stream configured to intersect in a micromixer region 276 connected to an outlet channel 278 for outputting a third stream of biphasic fluid in which a mass percentage of the first compound transfers into the organic solvent. However, the first liquid-liquid biphasic micro-fluidic flow channel reactor may have any suitable micromixer configuration, including, but not limited to, a T-junction or a Y-junction. Also depicted in FIG. 2 is a heating chamber 280 surrounding the outlet channel, which in embodiments (as described below), may preferably comprise a microwave heating chamber.

As shown in FIG. 1, the method 100 comprises a step 120 of providing a plurality of computational fluid dynamics (CFD) datasets as a function of the aqueous phase, the organic phase, and an inner diameter of the first liquid-liquid biphasic micro-fluidic flow channel reactor. The method 100 also comprises a step 130 of developing at least one active machine learning (ML) model to predict biphasic flow patterns and mass transfer rate in the micro-fluidic flow channel, wherein the at least one active ML model uses a training subset of the plurality of experimental datasets and a training subset of the plurality of CFD datasets; a step 140 of testing the efficacy of the at least one active ML model using a remaining testing subset of the plurality of experimental datasets and a remaining testing subset of the plurality of CFD datasets not used for the at least one active ML model; and a step 150 of generating a mathematical expression for determining a maximum mass transfer rate as a function of inner diameter and length of the outlet channel, using the at least one active ML model. The method 100 further comprises a step of designing a second liquid-liquid biphasic micro-fluidic flow channel reactor, having the same micromixer configuration and the same organic and aqueous phases as that of the first liquid-liquid biphasic micro-fluidic flow channel reactor, using the mathematical expression, such that a second inner diameter of the second liquid-liquid biphasic micro-fluidic flow channel reactor is greater than the first inner diameter, and whereby a second throughput of second liquid-liquid biphasic micro-fluidic flow channel reactor is greater than a first throughput of the first liquid-liquid biphasic micro-fluidic flow channel reactor.

In an embodiment of the method 100, the organic phase may comprise a second compound dispersed in the organic solvent, wherein the biphasic fluid comprises a third compound which is a product of a reaction between the first compound and the second compound.

In embodiments, the step 120 of providing a plurality of CFD datasets comprises performing principal component analysis (PCA) to identify one or more features, including material properties and dimensionless parameters, for both the aqueous phase and the organic phase that have an impact on the liquid-liquid biphasic micro-fluidic flow channel reactor's behaviour. Suitable examples of the features for each of the aqueous phase and the organic phase include kinematic viscosity (μ), density (φ, velocity (u), Capillary number (Ca), Reynolds number (Re), Weber number (We), Ohnesorge number (Oh), and Diffusivity (D).

Step 130 of developing the at least one active ML model may include using a random forest algorithm to predict biphasic flow patterns. Exemplary biphasic flow patterns include but are not limited to slug flow, drop flow, annular flow, parallel flow, and irregular flow, and combinations thereof (e.g. slug/drop flow). The response space of the at least one ML model may encompass the predicted biphasic flow patterns and predictors of the features required to represent the biphasic flow patterns for each of the aqueous phase and the organic phase.

Principal component analysis (PCA) may be performed to determine features to represent the mass transfer rate. Exemplary features include but are not limited to: Capillary number (Ca), Schmidt number over the partition coefficient (Sc/K, discussed below in more detail), and the length over the diameter (L/d).

In yet another embodiment, the step 130 of developing the at least one active ML model further comprises using symbolic genetic regression to develop a new functional form of mass transfer using the features identified by PCA to represent mass transfer rate.

Thus, based on data developed using a first liquid-liquid biphasic micro-fluidic flow channel reactor having a first inner diameter in the range of 300 micronmeters-6 mm, inclusive, a second liquid-liquid biphasic micro-fluidic flow channel reactor having a second inner diameter in the range of 300 micronmeters-6 mm, inclusive can be designed using embodiments of the method as discussed herein.

Embodiments of the method were developed using exemplary systems comprising a specific set of compounds and chemistry, but the invention is not limited to any particular reactor inputs and outputs, reactions, or mass transfer systems. In the exemplary embodiment, the first and the second liquid-liquid biphasic micro-fluidic flow channel reactors were configured to convert fructose or glucose to 5-hydroxymethylfurfural (HMF) and extract HMF from the aqueous phase to the organic phase. In this system, the aqueous phase comprises 5-hydroxymethylfurfural (HMF) as the first compound. In one embodiment, the liquid-liquid biphasic micro-fluidic flow channel reactor converts the fructose to HMF via a Brønsted acid-catalyzed fructose dehydration under suitable reaction conditions. In another embodiment, the liquid-liquid biphasic micro-fluidic flow channel reactor converts glucose to HMF via a Lewis and Brønsted acid-catalyzed isomerization and dehydration reaction under suitable reaction conditions. So, in the exemplary embodiments, the aqueous phase included (i) fructose and/or glucose and a Brønsted acid-catalyst used for dehydration of fructose and/or glucose to yield the HMF, or (ii) glucose and Lewis and Bronsted acid catalysts for an isomerization and dehydration reaction to yield the HMF.

In the exemplary embodiment, suitable Brønsted acid catalysts that can be employed in the method disclosed herein include, but are not limited to, acetic acid, hydrochloric acid, hydrobromic acid, nitric acid, sulfuric acid, perchloric acid phosphoric acid, or any combination thereof, preferably hydrochloric acid. Suitable Lewis acid catalysts that can be employed in the method disclosed herein include, but are not limited to, ZnCl₂, BF₃, SnCl₄, AlCl₃, LiBr, CrCl₃, DyCl₃, VCl₃, YbCl₃, RuCl₃, and MeAlCl₂, or any combination thereof. Likewise, any suitable organic solvent may be used in the organic phase, including but not limited to, ethyl acetate, methyl isobutyl ketone, large alcohols or ketones (i.e. effectively including all alcohols and ketones with 3 to 7 carbons, including but not limited to: 2-pentanone, 2-butanone, 4-heptanone, 2-pentanol, 1-butanol, 2-butanol, gamma valerolactone), or combinations thereof.

For the exemplary embodiment, the first and the second liquid-liquid biphasic micro-fluidic flow channel reactor were defined by a T-junction micromixer configuration, and the optimal biphasic fluid pattern was found to be slug flow.

In this exemplary embodiment, the method included the use of symbolic genetic regression to define a mathematical expression as defined by equation (1), herein above. Constants α, β, γ, and δ were determined from regressing to experimental or computational data or both.

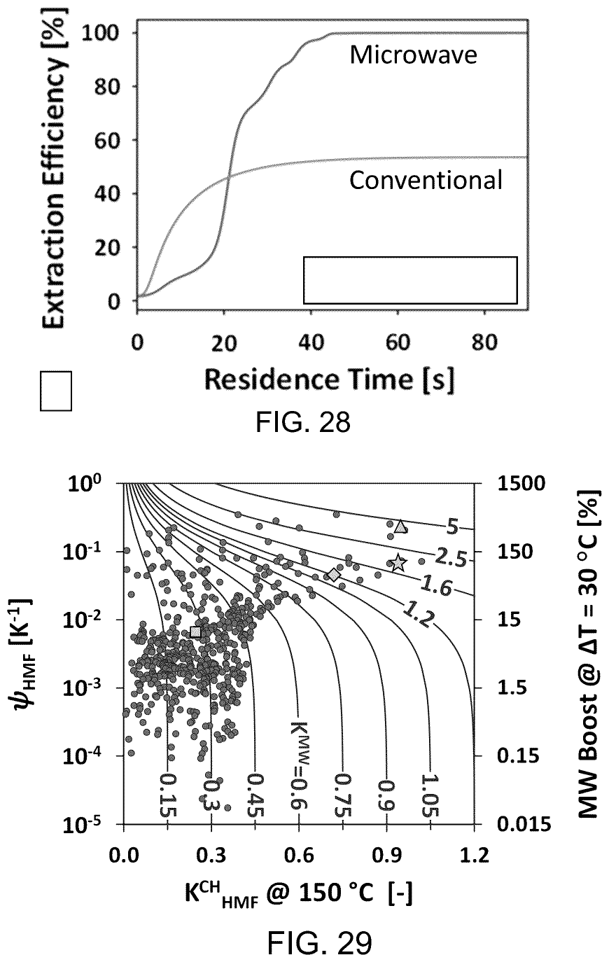

In the exemplary embodiment, the method included microwave-assisted heating of the biphasic fluid in the outlet channel, such as by arrangement of the output stream within a microwave-heating chamber configured to direct microwave energy into the output stream. Microwave heating chambers are generally known, as are the types of materials suitable for repeated microwave heating without degradation for use as materials of construction for the outlet stream conduit. Without wishing to be bound by any theory, it is believed that microwave-assisted heating enhances separation due to generation of temperature gradients, which in turn drives mass transfer due to density gradients caused by the non-thermal equilibrium in the system. Greater than 20% energy savings was observed. MW-heated reactive extractions have also been shown to suppress byproduct formation. The faster mass transfer performance allows for faster rates or use of a smaller reactor size to achieve the same rate, both of which have financial benefits. FIG. 28 depicts extraction efficiency as a function of residence time for conventional heating as compared to microwave heating for an equivalent amount of heat input, based upon simulated data. As shown in FIG. 28, conventional also provides benefits as compared to systems with no heating at all. Details relating to MW-enhanced extractions are discussed in more detail herein below.

In the exemplary embodiment, the liquid-liquid biphasic micro-fluidic flow channel reactor comprises a first inlet channel configured to receive a stream of an aqueous phase comprising 5-hydroxymethylfurfural (HMF) and a second inlet channel configured to receive a stream of an organic solvent for extracting HMF from the aqueous phase. The organic solvent may be selected from the group consisting of: ethyl acetate, 2-pentanol, methyl isobutyl ketone, and a combination thereof. The first inlet channel and second inlet channel intersect in a micromixer region, namely a T-junction micromixer, connected to an outlet channel configured to receive a stream of biphasic fluid comprising the HMF in the aqueous phase and the organic solvent. The reactor was configured in conformance with mathematical expression (1) derived using the methodology as described herein.

In the exemplary HMF embodiment, α may be in a range of 0.5-20; β may be in a range of 0.1-10; γ may be in a range of 0.1-10; and δ may be in a range of 0.1-5.

In the exemplary embodiment of preparing 5-hydroxymethylfurfural as described, the aqueous phase has a concentration of the glucose or fructose in a range of about 0.05 M to about 0.3 M, such as about 0.05 M to about 0.2 M, such as about 0.05 M to about 0.1 M, such as about 0.1 M to about 0.3 M, such as about 0.1 M to about 0.2 M. The aqueous phase has a concentration of the Brønsted acid catalyst in a range of about 0.25 M to about 1.0 M, such as about 0.25 M to about 0.8 M, such as about 0.25 M to about 0.6 M, such as about 0.25 M to about 0.4 M, such as about 0.35 M to about 1.0 M, such as about 0.35 M to about 0.8 M, such as about 0.35 M to about 0.6 M, such as about 0.5 M to about 1.0 M.

The glucose or fructose may be obtained, for example, by contacting cellulose with an acidic aqueous solution. The cellulose that serves as the source of the glucose or fructose may be obtained from a lignocellulosic biomass, such as a non-edible lignocellulosic biomass, energy crops, agricultural waste, and forestry waste.

The 5-hydroxymethylfurfural so obtained may comprise at least 50% (molar yield of carbon from the sugar going into the product), such as at least 60%, such as at least 70%, such as at least 80%, such as at least 90%, such as at least 99%, such as about 50% to about 99%, such as about 65% to about 99%, such as about 75% to about 99%, such as about 50% to about 85%, such as about 55% to about 85%, such as about 60% to about 85%, such as about 65% to about 80%, based on the amount of glucose or fructose starting material.

The reaction time may be up to 300 minutes, such as up to 200 minutes, such as up to 120 minutes, such as from about 15 minutes to about 300 minutes, such as about 30 minutes to about 300 minutes, such as about 60 minutes to about 300 minutes, such as about 90 minutes to about 300 minutes, such as about 120 minutes to about 300 minutes, such as about 180 minutes to about 300 minutes, such as about 60 minutes to about 200 minutes, such as about 90 minutes to about 200 minutes, such as about 120 minutes to about 200 minutes.

The reaction temperature may range from about 105° C. to about 145° C., such as about 105° C. to about 135° C., such as about 105° C. to about 125° C., such as about 105° C. to about 115° C., such as about 110° C. to about 135° C., such as about 110° C. to about 125° C., such as about 110° C. to about 115° C., such as about 120° C. to about 145° C., such as about 120° C. to about 135° C.

The method of designing a modular micro- or milli-fluidic flow channel reactor as described herein is not limited to any particular set of input and output streams in need of mass transfer. In embodiments, the method may be ideal for determining an optimum inner radius for each flow channel for a product stream and/or a waste stream, wherein the product stream comprises biomass known to be a feedstock for production of renewable fuels, chemicals, and bioplastics, and wherein the waste stream comprises food waste, agricultural waste, and/or forestry waste. While one example is lignocellulosic biomass, grown for conversion of glucose and fructose to 5-hydroxymethylfurfural (HMF), the method is not limited thereto. The biomass may be intentionally grown for the purpose of production of renewable fuels, chemicals, and bioplastics, or may be an agricultural byproduct.

Within this specification, embodiments have been described in a way which enables a clear and concise specification to be written, but it is intended and will be appreciated that embodiments may be variously combined or separated without departing from the invention. For example, it will be appreciated that all preferred features described herein are applicable to all aspects of the invention described herein.

In some embodiments, the invention herein can be construed as excluding any element or process step that does not materially affect the basic and novel characteristics of the compositions or processes. Additionally, in some embodiments, the invention can be construed as excluding any element or process step not specified herein.

### Solvent Selection for MW-Enhanced Extractions

The techniques discussed below are discussed in more detail in Montgomery Baker-Fales, Tai-Ying Chen, Pooja Bhalode, Zhaoxing Wang, Dionisios G. Vlachos. “Microwave enhancement of extractions and reactions in Liquid-Liquid biphasic systems,” Chemical Engineering Journal, Volume 476, 2023,146552, incorporated herein in its entirety by reference. Leveraging the Conductor-like Screening MOdel for Realistic Solvents (COSMO-RS), a 2-step model, as a method for calculating the chemical potentials and partition coefficients, the standard chemical potential of HMF in water

$$( {μ}_{HMF , aq}^{*} )$$

and various organic solvents

$$( {μ}_{HMF , org}^{*} )$$

was calculated to estimate K_{HMF}. The chemical potential is related to partitioning as shown in Eqs. (MW1)-(MW3), shown below.

$${μ}_{i , j} ( {T}_{j} , P ) = {μ}_{i , j}^{*} ( {T}_{j} , P ) + {RT}_{j} {lnx}_{i , j} \qquad ( MW 1 )$$

$${μ}_{i , aq}^{*} ( {T}_{aq} , P ) + {RT}_{aq} {lnx}_{i , aq} = {μ}_{i , org}^{*} ( {T}_{org} , P ) + {RT}_{org} {lnx}_{i , org} \qquad ( MW 2 )$$

$$\frac{{x}_{i , org}}{{x}_{i , aq}} = {e}^{\frac{{μ}_{i , aq}^{*} ( T , P ) - {μ}_{i , org}^{*} ( T , P )}{RT}} \qquad ( MW 3 )$$

In Eq. (MW1), μ_{i,j} is the chemical potential of species i in phase j;

$${μ}_{i , j}^{*}$$

standard chemical potential of species i in phase j; Tⱼ is the temperature in phase j; P is the pressure; R is the ideal gas constant; x_{i,j} is the mole fraction of species i in phase j; and j is either the aqueous or organic phase. At equilibrium, the chemical potential of species i in each phase is the same, Eq. (MW2). In conventionally heated systems, where T_{aq}=T_{org}, Eq. (MW2) is rearranged to define the molar distribution of species i as shown in Eq. (MW3). Finally, Kᵢ is extracted by converting x_{i,j} into C_{i,j} as shown in Eq. (MW4), where Mⱼ and ρⱼ are the molar mass and mass density of each phase, respectively

$${K}_{i} = \frac{{C}_{i , org}}{{C}_{i , aq}} = \frac{{M}_{aq} {ρ}_{org}}{{M}_{org} {ρ}_{aq}} \cdot \frac{{x}_{i , org}}{{x}_{i , aq}} \qquad ( MW 4 )$$

MW enhancements in solute partitioning depend upon the variance of partitioning with temperature. A coefficient of thermal partitioning variance, ψᵢ, is defined as shown in Eq. (MW5),

$${ψ}_{i} = \frac{1}{{K}_{i}^{CH} {\vert}_{{T}_{aq}}} ( - \frac{{dK}_{i}^{CH}}{dT} ) \qquad ( MW5 )$$

$${K}_{i}^{MW} = {K}_{i}^{CH} {\vert}_{{T}_{aq}} ( 1 + {ψ}_{i} ( {T}_{aq} - {T}_{int} ) ) \qquad ( MW6 )$$

where

$${K}_{i}^{CH} and {K}_{i}^{MW}$$

represent the partition coefficients of a solute i in conventionally heated (CH) and MW-heated systems, respectively.

$${K}_{i}^{CH} {\vert}_{{T}_{aq}}$$

is the partition coefficient for a conventionally-heated system held at the temperature of the MW-heated aqueous phase. Eq. (MW6) estimates partitioning enhancements in MW-heated systems (ψᵢ is assumed constant over the small ΔT).

COSMO-RS was used to calculate the chemical potential of HMF across a range of temperatures near T=160° C. in both aqueous and organic (MIBK) phases. It was estimated that ψ_{HMF}=0.0064 for the water/MIBK system. Given the experimentally measured

$${K}_{HMF}^{CH} = 0 \text{.792}$$

at 160° C., and T_{aq}−Tᵢₙₜ=15° C. in the MW-heated system, it is calculated that

$${K}_{HMF}^{MW} = 0.867$$

via Eq. (MW6). This closely aligns with the measured

$${K}_{HMF}^{MW} = 0.862 ,$$

supporting the proposed

$${K}_{i}^{MW}$$

estimation methodology.

Thus, microwave (MW) heating may have particular advantages for use in systems featuring solvents with relatively greater partitioning sensitivity. For example, as discussed above, for MIBK, the MW enhancement is small, due to relatively stable partitioning selectivity with increasing temperature. But many solvents lose partitioning selectivity more dramatically. For example, m-cresol has been experimentally shown to have K_{HMF}=20.6 and 4.2 at 25° C. and 150° C., respectively, indicating that ψ_{HMF} could be much larger in other solvents. See, Z. Wang, S. Bhattacharyya, D. G. Vlachos, “Solvent selection for biphasic extraction of 5-hydroxymethylfurfural via multiscale modeling and experiments,” Green Chemistry. 22 (2020) 8699-8712. Screening for suitable MW extraction solvent candidates is a task well-suited to COSMO-RS, which was recently used for conventionally heated HMF extractions, as discussed by Wang et al., supra, which details a survey of approximately 2,500 solvents for HMF partitioning and reports HMF distribution data at 25° C. and 150° C. This data alone can be used to estimate ψ_{HMF}. In FIG. 29, ψ_{HMF} values for 536 solvents for which MWs provide an enhancing effect (i.e., ψ_{HMF}>0) are plotted against K_{HMF} to illustrate solvent suitability. The magnitude of ψ_{HMF} for these solvents ranges from 10-5 K-1 to >10-1 K-1, indicating substantial variations in MW performance.

To calculate the MW-induced partitioning enhancement, T_{aq}-Tᵢₙₜ may be estimated for each solvent system. To do this, it is first assumed that T_{aq}-Tᵢₙₜ˜ΔT/2 (which is observed to be true for the water/MIBK system), and that ΔT=30° C. is generally achievable across most solvents when ionic species are present (see Figure S6). Therefore, the MW-induced partitioning enhancement is estimated using T_{aq}-Tᵢₙₜ=15° C. Many solvents are more promising compared to those used in MW extraction literature, which include dichloroethane, methylene chloride, gamma-valerolactone, and toluene, with microwave-induced partitioning changes of +2.6%, −10.8%, −10.4%, and −0.6%, respectively. In contrast, high-performing solvents, such as m-cresol, p-chlorophenol, and indole, have MW partitioning boosts of +68%, +97%, and +329%, respectively,

Furthermore, an unexpected phenomenon observed in the MW-heated liquid-liquid extractions was that of Rayleigh convection. The density difference between water and the organic phase is amplified due to temperature gradients, setting up a buoyancy-driven convection that was clearly visible to the naked eye when Pyrex vials were used. The Rayleigh number (Ra) is the ratio between the convective and diffusive thermal transport at a certain velocity induced by the density difference to evaluate the improved extraction caused by convection:

$$Ra = \frac{ρβΔ {Tl}^{3} g}{η α} \qquad ( 23 )$$

### Wherein:

β is the thermal expansion coefficient; η is the dynamic viscosity; I the characteristic length of the system; and α the thermal diffusivity. The Ra number increases as the characteristic length increases due to a longer transport distance, where convective thermal transport is much faster and more significant than diffusive thermal transport. The Ra number also increases with increasing ΔT.

This density driven convection also affects mass transport in a similar manner. The mass-based Peclet number (Pe) is the ratio of convective to diffusive mass transport

$$P e = \frac{lU}{D} = \frac{ρβΔ {Tl}^{3} g}{η D} \qquad ( 24 )$$

### Wherein:

D is the diffusion coefficient. Similarly to Ra, the Pe number increases as the characteristic length increases due to a longer transport distance, where convective mass transport is much faster and more significant than diffusive mass transport. The Pe number increases with increasing ΔT. Even for a microsystem (I˜1 mm) or a minimal temperature difference (ΔT˜ 0.2° C.), convective HMF transport is faster than diffusive transport by an order of magnitude (Pe=10) due to the low species diffusivity in the liquid phase. For larger geometries (˜40 mm), the Pe is expected to be >1000 even with a very small ΔT, indicating dominant convective mass transport due to the application of MWs.

### EXAMPLES

Examples of the present invention will now be described. The technical scope of the present invention is not limited to the examples described below.

The structure of the details of a Working Example according to embodiments of the present invention, disclosed hereinbelow, is as follows. First, the experimental and computational methodology to investigate liquid-liquid flow patterns and mass transfer rate are introduced, followed by the need to use a hybrid data set and account for uncertainties. The Results and Discussion section details the simulation and experimental data for flow patterns followed by the mass transfer rate topic.

### Example 1

### Systems and Methods

### T-junction Microchannel

The example used a horizontally placed T-junction microchannel, with an organic phase and an aqueous phase mix, as shown in FIG. 2. A T-junction was selected for enhanced mass transfer due to increased interfacial area created at the junction when the liquids come in contact. T-junctions are suitable to be scaled-up in industrial processes. The interplay of viscous, interfacial, inertial, and gravitational forces creates multiple flow patterns identified based on standard definitions. For the mass transfer example, an aqueous phase consisting of HMF and an organic phase free of HMF were sent to the T-junction, and the HMF was transferred from the aqueous phase to the organic phase.

### Experimental Methods

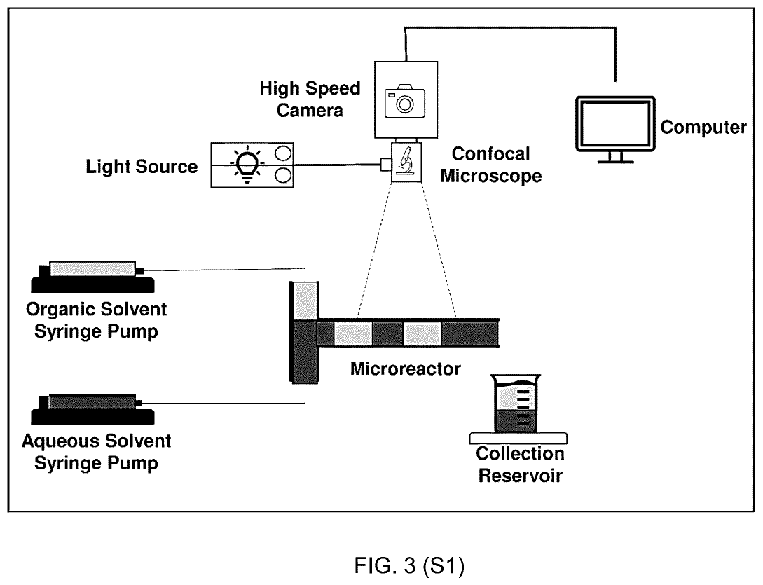

Two syringe pumps (ReaXus LS Class High Performance Isocratic pumps) were used to pump the aqueous and organic solvent feed into a square cross-section T-junction (Valco Instruments) made of polyether ketone (PEEK), as seen in FIG. 3. The biphasic mixture then entered a capillary made of perfluoroalkoxy alkane (PFA) tubing (Index Health) with alternating coiled and straight segments of ID=1.6 mm and 4.8 mm for flow pattern studies, and ID=0.5 mm, 1 mm, and 1.6 mm and L=17 cm, 8.5 cm, and 5 cm, respectively, for mass transfer rate studies. Deionized water (Milli-Q) was the aqueous solvent. MIBK 99% (Sigma Aldrich) or 2-pentanol 99% (Sigma Aldrich) was used as the organic solvent. Sodium fluorescein 99% (Sigma Aldrich) and 9,10-diphenylanthracene 99% (Sigma Aldrich) were used as the aqueous fluorescent dye and organic fluorescent, respectively, to contrast the two liquid phases during flow visualization.

The flow patterns were characterized using laser induced fluorescence (LIF) of 250 μM solution of sodium fluorescence in water and a 10 mM of 9,10-diphenylanthracene solution in one of the selected organic solvents, using a high-speed confocal microscope (Highspeed LSM 5 Live Duo) mounted with an inverter. Two laser sources with a wavelength of 488 nm and 405 nm were used for the fluorescence excitation of the aqueous and organic solvents, respectively. Images were captured using Zeiss 1.25× and a 2.5× Plan-Neofluar objective lens at frame rates ranging from 30 to 108.1 fps. Further image analysis and processing of the flow patterns were conducted in ImageJ.

For mass transfer, an aqueous feed of 0.1 wt % HMF in water encounters a neat organic feed at the T-junction. As the biphasic mixture flows, the exit stream is collected in a 10 ml graduated cylinder placed directly below the outlet of the microchannel. As the two-phases settle, immediate phase separation is observed for the solvent pairs. Using a 2 ml plastic pipette, the top organic phase is quickly removed from the graduated cylinder. Then small aliquots of the aqueous phase are pipetted into 300 μL vials for post-extraction analysis. The rate of mass transfer in the sampling zone is evaluated using the procedure reported by Zhao et al. See, Zhao, Y.; Chen, G.; Yuan, Q., “Liquid-liquid two-phase mass transfer in the T-junction microchannels.” AIChE Journal, 2007, 53 (12), 3042-3053.

### Computational Methods

CFD simulations of two-phase flow were conducted using the COMSOL Multiphysics 5.4 software. A laminar flow module was used to compute the velocity and pressure fields by solving the Navier-stokes Eq. NS1.

$$ρ \frac{D u}{Dt} = - ∇ ρ + ∇ \cdot τ + ρ g \qquad ( NS 1 )$$

A two-phase flow, phase-field model, was used to define the parameters controlling the interface thickness and mobility. The contact angle of the fluid was specified to be 90°. The continuous species transfer (CST) model (Eq. 2) accounts for mass transfer between phases, for a given species j.

$$\frac{\partial {C}_{j}}{\partial t} + ∇ \cdot ( {C}_{j} \cdot U ) = ∇ \cdot ( {D}_{j} ∇ {C}_{j} + {Φ}_{j} ) \qquad ( 2 )$$

This approach introduces a single-field representation and considers the concentration difference in the two phases at the interface with the discontinuity factor Φ, Eq. 3, where C is the single field concentration; Dⱼ is the harmonic mean of the diffusivity of species j in the two phases weighed but the volume fractions, as in Eq. 4; α represents the aqueous volume fraction calculated using the phase field module; and K represents the partition coefficient, as in Eq. 5.

$${Φ}_{j} = - ( \frac{D ( 1 - K )}{α + K ( 1 - α )} ) \qquad ( 3 )$$

$$Dj = \frac{1}{\frac{α}{{D}_{j , 1}} + \frac{1 - α}{{D}_{j , 2}}} \qquad ( 4 )$$

$$K = \frac{{C}_{j , 1}}{{C}_{j , 2}} \qquad ( 5 )$$

The flow patterns and rate of mass transfer were independent of the cell number and size of discretization. Zero gradient for the pressure and no-slip boundary condition for the velocity are implemented at the wall. A fully developed flow is assumed at the inlet. At the outlet, the velocity is set to be zero-gradient, and the pressure to be atmospheric. A simulation of a total of 1,000,000 to 2,000,000 nodes takes between 18-24 h computing time using 36 CPUs (Intel E5-2695V4) on a high-performance computing cluster to obtain one flow pattern and 48-72 h for mass transfer data. For this work, we used water and ethyl acetate (EtAc), MIBK, or pentanol.

The volumetric mass transfer coefficient (k a) was calculated using the outlet concentration of HMF in the organic phase using Eq. 6, derived from a simple biphasic, plug flow, mass transfer model. Eq. 6 applied to the CFD and experimental data.

$${k}_{L} a = rate of mass transfer = \frac{1}{τ ( \frac{K}{{ε}_{a q}} + \frac{1}{{ε}_{o r g}} )} ln ( \frac{{C}_{o r g}^{e q} - {C}_{o r g}^{i n}}{{C}_{o r g}^{e q} - {C}_{o r g}^{o u t}} ) \qquad ( 6 )$$

Here k_{L} is the mass transfer coefficient and a is the specific interfacial area. τ represents the residence time, ε_{aq} and ε_{org} the volume fractions of the aqueous and organic phases, respectively, and

$${C}_{o r g}^{e q} , {C}_{o r g}^{i n} , and {C}_{o r g}^{out}$$

the HMF concentration in the organic phase at equilibrium, inlet, and outlet of the microchannel, respectively.

### Features

Principal component analysis (PCA) was used to identify the number of features required to capture the system's behavior. Considering material properties and dimensionless groups of both phases gave a total of 26 features (See Table 1 and definitions in the Supplemental Information (SI) herein below). The material properties in the CFD model are shown in Table 1. The dimensionless groups were based on previous work. See, e.g., Chen, supra; Zhao, Y.; Chen, G.; Yuan, Q. “Liquid-liquid two-phase flow patterns in a rectangular microchannel.” AIChE Journal 2006, 52 (12), 4052-4060; Yagodnitsyna, A. A.; Kovalev, A. V.; Bilsky, A. V. “Flow patterns of immiscible liquid-liquid flow in a rectangular microchannel with T-junction.” Chemical Engineering Journal 2016, 303, 547-554; Zhao, C. X.; Middelberg, A. P. J. “Two-phase microfluidic flows.” Chemical Engineering Science 2011, 66 (7), 1394-1411. Apart from PCA, feature importance can rank features for classifying flowpatterns. A clustered covariance matrix may be employed to group dependent variables. We implemented these algorithms using the sklearn library in Python.

TABLE 1
Features defining the flow patterns and mass
transfer rate in liquid-liquid microchannels

| | |
|---|---|
| Aqueous phase | Kinematic viscosity (μ), density (ρ), velocity (u), Capillary number (Ca), |
| (Aq) | Reynolds number (Re), Weber number (We), Ohnesorge number |
| | (Oh), and Diffusivity (D) |
| Organic phase | Kinematic viscosity (μ), density (ρ), velocity (u), Capillary number (Ca), |
| (Org) | Reynolds number (Re), Weber number (We), Ohnesorge number (Oh), |
| | and Diffusivity (D) |
| System-wide | Interfacial tension (σ), total flow rate (Q), flow rate ratio (org/aq), total |
| | velocity of the system (U), Bond number (Bo), partition coefficient (K), |
| | density ratio (ρᵣₐₜᵢₒ), mixture diffusivity (D_{M}), diameter (d), and length of |
| | the microchannel (L) |

### Random Forest

A random forest model was used to predict flow patterns. This is an ensemble method based on the decision tree algorithm. Random forest is a commonly used, supervised ML technique in data mining for predicting either the value (regression) or the class (classification) of target variables from input observations. The approach involves employing multiple decision trees, each splitting the dataset into subsets by selecting variables that separate the observations at each tree node of the tree. Gini impurity (for variable selection) is combined with a randomized search method to set the hyperparameters (such as number of trees, max depth, min features, bootstrapping) of the decision tree. The random forest algorithm is carried out using scikit-learn. The invention is not limited to use of the Random Forest model, however, as the XGBoost model would also be expected to achieve reasonable results.

The response space encompasses various flow patterns, while the predictors consist of the features. The experimental and CFD data is randomly split into a training set (80%) and a testing set (20%). A 3-fold cross-validation combined with a randomized search is employed to prevent overfitting. Because of the small dataset generated in this work (˜220 data obtained using CFD simulations and experiments), satisfactory accuracy was not achieved. Consequently, the random forest model was enhanced by leveraging a heterogenous dataset and active learning techniques, all while quantifying uncertainty (details provided below).

### Active Learning

Creating a reliable surrogate model benefits from having sufficient data, making it desirable to minimize the number of simulations and maximize the accuracy. For the examples discussed herein, the inventors used a pool-based sampling method, which is a frequently-used active learning algorithm, to select conditions for additional CFD simulations. The invention is not limited to the use of any particular sampling method, however, and may use any of the sampling methods known in the art, including but not limited to those discussed in Wang et al., “NEXTorch: A Design and Bayesian Optimization Toolkit for Chemical Sciences and Engineering,” J. Chem. Inf. Model. 2021, 61, 11, 5312-5319 (Oct. 25, 2021) and the supporting Information relating thereto, including but not limited to Full Factorial, Latin Hypercube Sampling (LHS)+Bayesian Optimization (BO), Random Sampling, Sobol Sequence, Box Behnken, or Central Composite sampling methods. A collection of data (unlabeled dataset) was created by varying the diameter from 2 to 5 mm and the flow rate ratio from 1 to 4 while keeping Re<2000. Multiple iterations were done to select points to maximize the accuracy of the random forest model. In each iteration, we used the random forest model to predict flow patterns, and a data point was selected whose addition to the training dataset (with the predicted label) would maximize accuracy (expressed as (number of correct predictions)/(size of the test data set)). The selected data point was then simulated using CFD, and the corrected label was added to the training set (labelled dataset). This process was repeated until the model accuracy did not improve. Using the pool-based method, 7 points were selected from the unlabeled pool, increasing the accuracy from 67% to 84%. Most points selected belong to the parallel, slug-drop, and irregular flow patterns, i.e., these were lacking types of data.

### Hybrid (Heterogeneous) Data

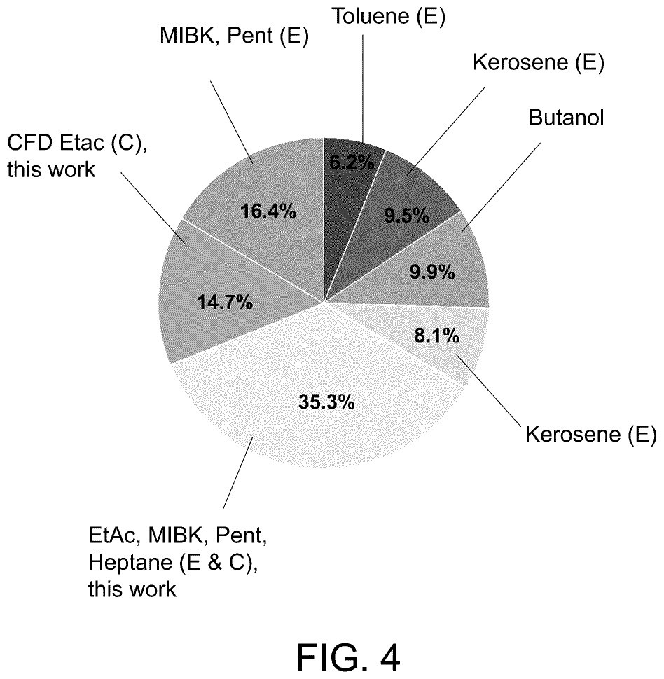

The inventors' experimental and CFD data was enhanced with mined flow pattern literature data relating to use of T-junction liquid-liquid microchannels, laminar flow, and a consistent definition of flow patterns. This diversified the solvents and diameters (from 0.2 to 5 mm), resulting in 730 total data points, as shown in FIG. 4.

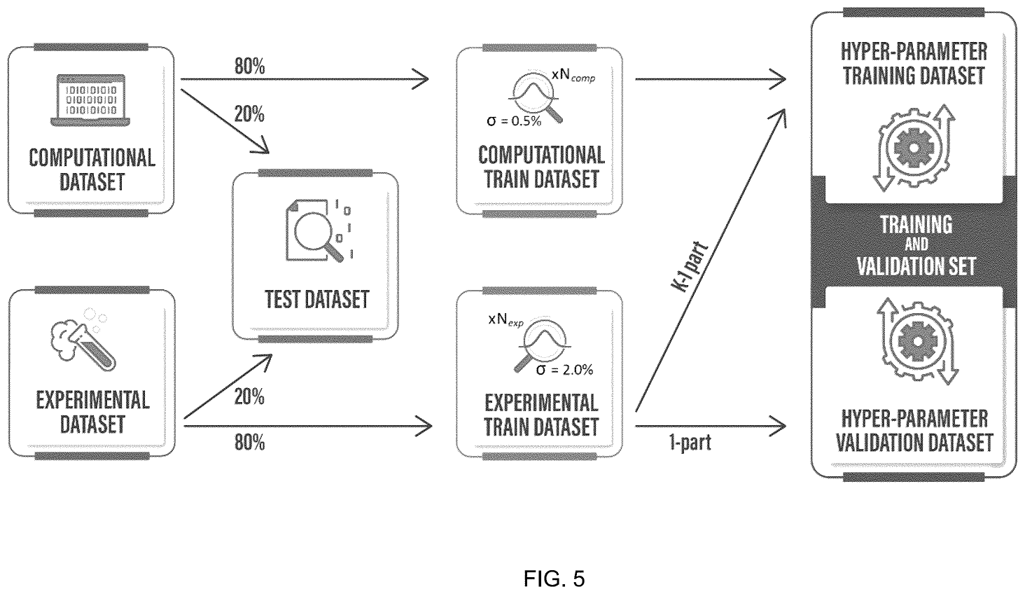

The experimental and CFD data are characterized by different degrees of uncertainty. Uncertainty in CFD stems from the solvers and meshing, resulting in 0.5% deviation (standard deviation of the outlet velocity simulated using d=0.5 mm, Q=10 ml/min & a flow rate ratio=1) in the predicted velocity, and the boundary condition regarding the wetting of the wall surface. Uncertainty in experiments is due to the high precision pumps. These pumps exhibit a 2% deviation (value taken from the brochure of ReaXus LS Class High Performance Isocratic pumps). We use these uncertainties to quantify their impact on flow patterns (FIG. 5).

First, the data was divided into computational and experimental sets, splitting each into test and training sets (20:80 ratio). The test data of both were combined. It was assumed that uncertainties are normally distributed (N(μ, σ)), where σ is 2% and 0.5% std. dev. for experimental and computational data, respectively. We sampled N_{comp} and Nₑₓₚ points for every computational and experimental data point, respectively, from the normal distribution, with a velocity as the mean. For this work we assumed, N_{comp}=400 and Nₑₓₚ=100. This approach weighed the data based on uncertainty

$$( \frac{{σ}_{comp}}{{σ}_{ex p}} ∝ \frac{{N}_{ex p}}{{N}_{comp}} ) .$$

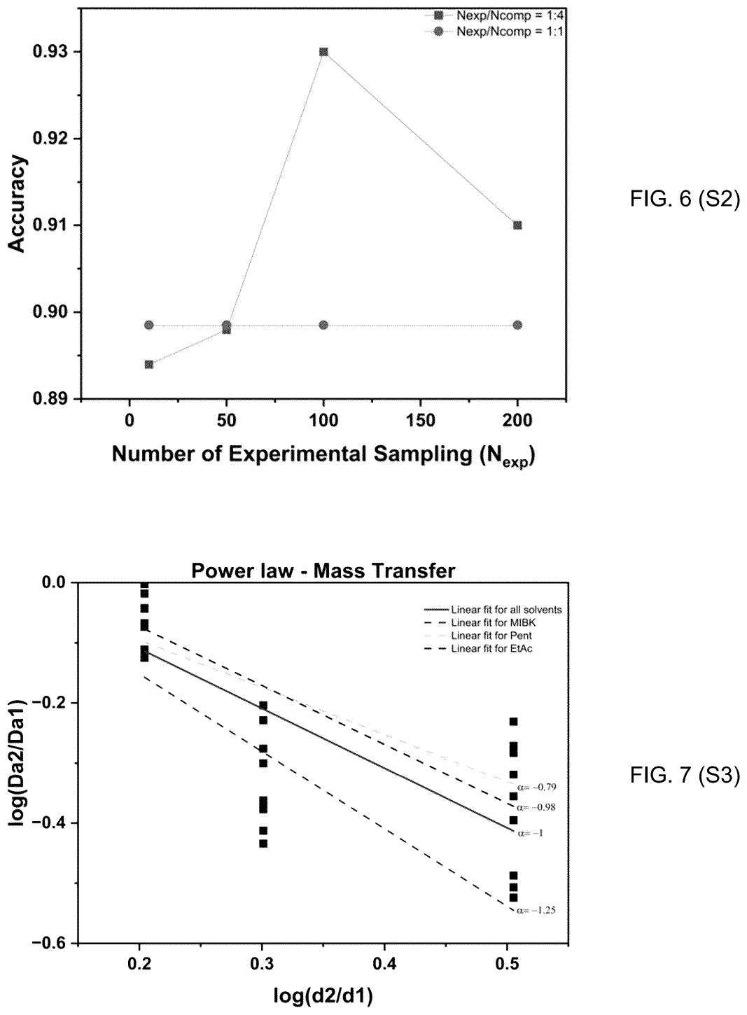

The convergence of the number samples was also studied (See FIG. 6). As the velocity varied, a probability of observing a flow pattern was defined.

The random forest hyper-parameters were determined using a modified 3-fold cross validation method combined with a randomized-grid search approach, where the ML model was trained on 2 parts out of the 3 of the experimental and computational training data and minimize the error with respect to the remaining experimental training data. See, Chheda, J. N.; Roman-Leshkov, Y.; Dumesic, J. A., “Production of 5-hydroxymethylfurfural and furfural by dehydration of biomass-derived mono- and poly-saccharides.” Green Chem., 2007, 9 (4), 342-350. The invention is not limited to any particular method for determining the random forest hyper-parameters.

### Symbolic Genetic Regression

Conventionally, the mass transfer rate is represented with a power law model (k_{L}α=α^{a}b^{β}c^{δ}, with a, b, and c being features selected, such as, for example, a=Reynolds number (Re), b=Capillary Number (Ca), and c=Weber number (We), and α, β, and δ being the respective exponents) and the parameters are estimated using logarithmic regression. the inventors; analysis revealed that the power or the leading coefficient of the logarithmic model changes with solvent properties (see SI, and FIG. 7), i.e., the traditional model does not transfer from one solvent to another. Symbolic genetic regression is a ML technique that ‘discovers’ a mathematical expression to describe the data best. See, e.g., Ansari, M.; Gandhi, H. A.; Foster, D. G.; White, A. D. “Iterative symbolic regression for learning transport equations.” AIChE Journal 2022, 68 (6); Ben Chaabene, W.; Nehdi, M. L. “Genetic programming based symbolic regression for shear capacity prediction of SFRC beams.” Construction and Building Materials, 2021, 280, 122523. It first builds a population of naïve random formulae to relate independent and dependent variables. Each successive generation is then evolved by selecting individuals from the population to undergo specified genetic operations based on the probabilities of the genetic operations as the input.

A symbolic regression using the gplearn library of python, was performed with an initial population size of 200,000 and a functional set including (‘add (+)’,‘sub (−)’,‘div (/)’, ‘mul (*)’, ‘neg (−1*)’, ‘inv (1/)’, ‘sqrt’, ‘log’, ‘exp’). The algorithm was run until the stopping criterion (mean square error <0.01) was reached or until 300 generations were created. The probabilities of various genetic operations were selected to maximize crossover and minimize point mutation.

The response space includes Da′ (the ratio of Damkohler (I) to Damkohler (II); see SI for definitions). Da′ includes τ multiplied with the mass transfer coefficient (k_{L}α). The predictors are Ca,

$$\frac{S c}{K} , and \frac{L}{d}$$

selected using feature algorithms. The data collected using experiments is randomly split into training (80%) and testing (20%) sets.

### Results and Discussion

### Liquid-liquid Flow Patterns

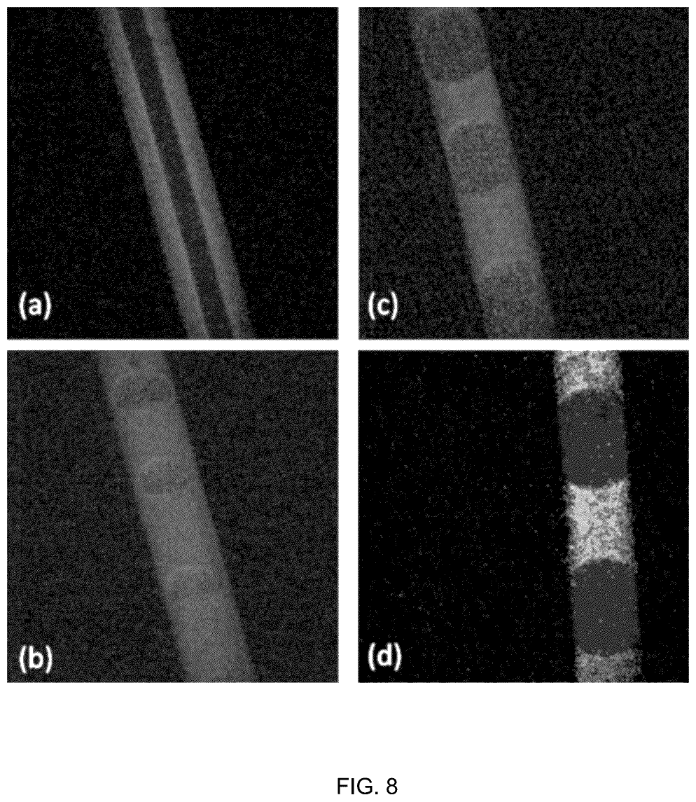

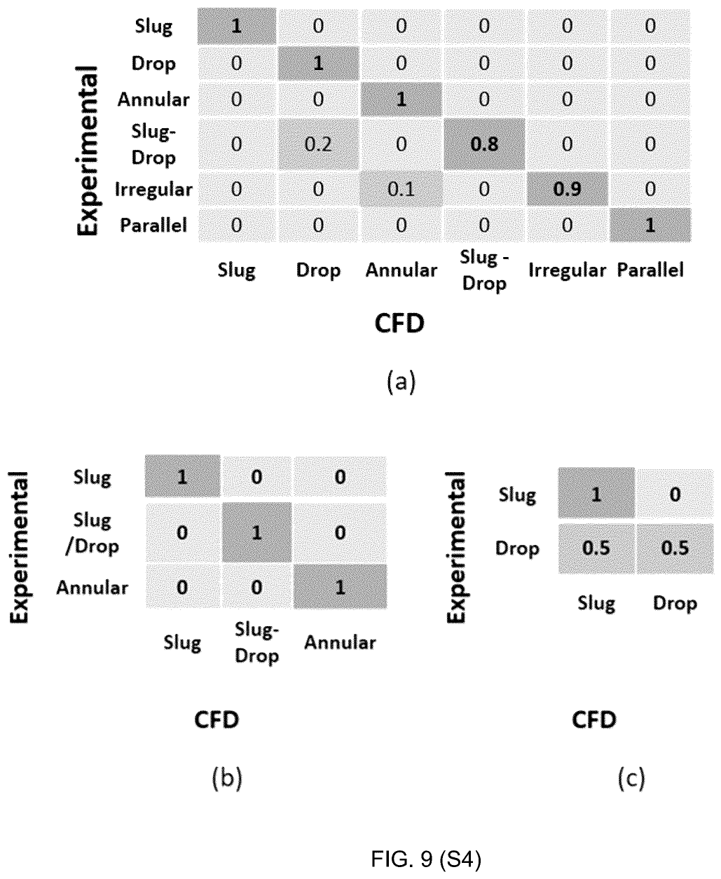

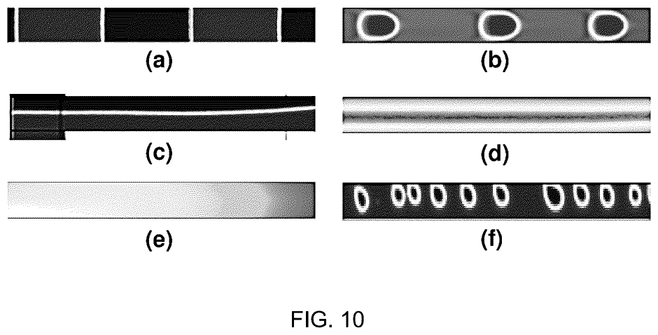

FIG. 8 shows the two-phase flow patterns (slug, drop, slug/droplet, and annular) observed experimentally using MIBK or 2-pentanol. The CFD model was assessed against new experiments for MIBK and 2-pentanol for d=1.6 mm and for EtAc using the experiments by Desir et al. for d=0.5 mm (at a flow rate ratio of 1). The flow patterns were in general agreement, as indicated by the confusion matrix in FIG. 9. FIG. 10 shows six computational flow patterns: (a) slug, (b) parallel, (c) drop, (d) slug/drop, (e) annular, and (f) irregular) using EtAc, which was chosen because it shows all flow patterns within the relevant range of velocity and diameter and is another important solvent for HMF extraction. As shown in FIGS. 8 and 10, the organic phase is continuous, and the aqueous phase is the dispersed phase.

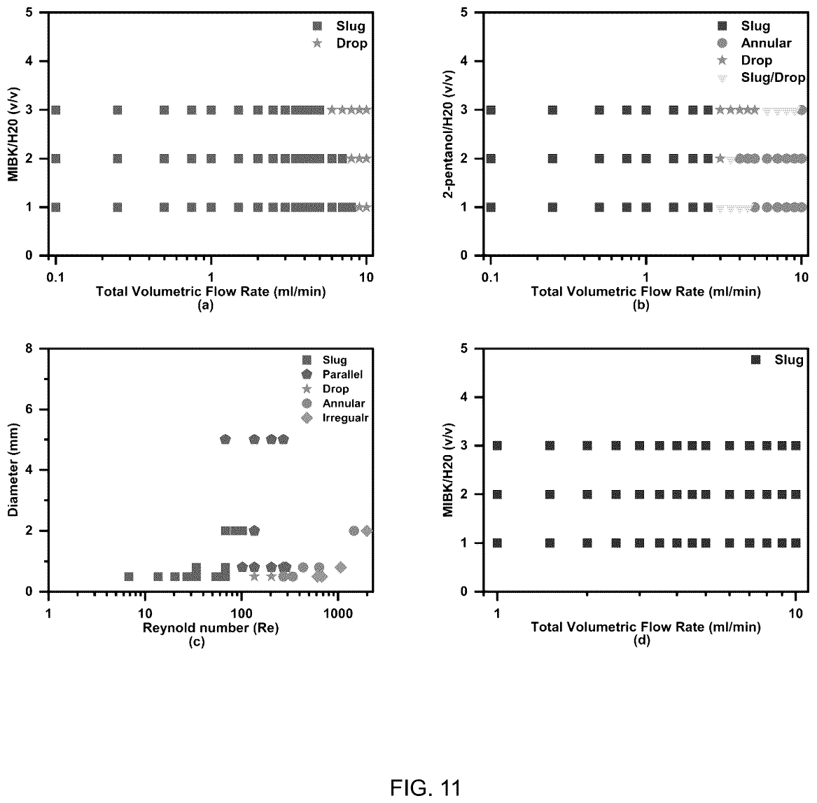

FIG. 11a, b, d and FIG. 11c maps the conditions for our experimental and computational flow patterns, respectively. As the diameter increases, different flow conditions (total volumetric flow rate, org/aq (v/v) ratio, various organic solvents) lead to varying patterns. Interestingly, slug flow still occurs using MIBK and 4.8 mm diameter because the velocity is lower for larger diameters and the same flow rate. For larger diameters, the parallel flow becomes prominent (FIG. 11c). Solvents affect the flow patterns due to different interfacial tension and viscosity, despite comparable density (Table 2). At lower experimental flow rates (0.1-10 ml/min), no irregular flow is observed.

TABLE 2
Organic solvent properties

| | Dynamic | | | | Partition |
|---|---|---|---|---|---|
| Organic | viscosity | Density | Interfacial | Diffusivity* | Coefficient* |
| solvent | (Pa · s) | (kg m⁻³) | Tension (N m⁻¹) | (m²/s) | (—) |
| EtAc | 4.41 × 10⁻⁴ | 900 | 0.0074 | 2.87 × 10⁻⁹ | 1.4 ± 0.05 |
| 2-pentanol | 3.47 × 10⁻³ | 812 | 0.0034 | 3.81 × 10⁻¹⁰ | 1.3 ± 0.07 |
| MIBK | 5.85 × 10⁻⁴ | 684 | 0.0157 | 2.43 × 10⁻⁹ | 1.1 ± 0.03 |

*Per Chen et al., supra.

### Feature Selection

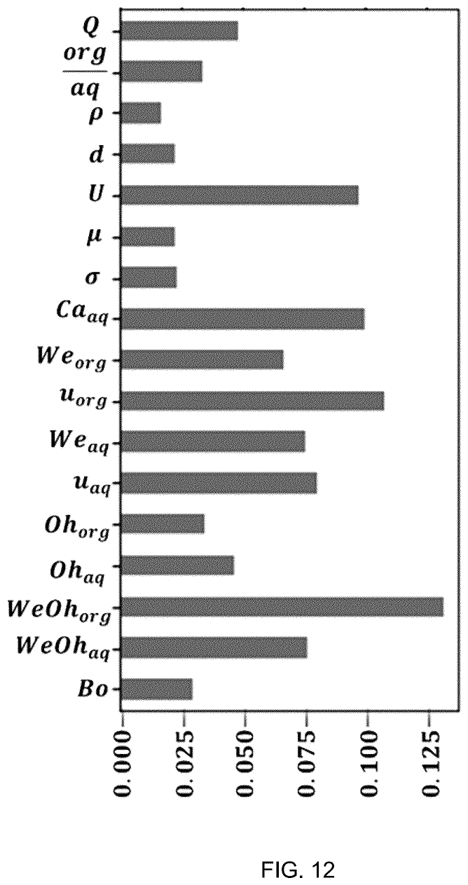

Previous work for a constant diameter using PCA revealed that at least 6 features are needed to represent flow patterns. FIG. 12 shows the mean decrease in impurity (average reduction in impurity when the feature is used as splitting criterion throughout the decision tree construction process) for various features. The Random Forest model was found to be the best among models explored and was built using the top 6 features (further increase in number of features resulted in decreased accuracy and an increase in deviation for 3-fold cross validation). The selected features include the total velocity of the flow (U) and those of the organic (u_{org}) and the aqueous phase (u_{aq}), the Capillary number of the aqueous phase (Ca_{aq}), and the product of the Weber and the Ohnesorge numbers of the organic and aqueous phases (WeOh_{aq}, WeOh_{org}). We-related dimensionless numbers were found to be more important in connection with scale-up the microchannels. The invention is not limited to any particular model, as the best model depends on the problem to be solved, with Random Forest often being one of the best of models considered, but XGBoost, for example, being another model that may be acceptable.

### Flow Pattern Prediction

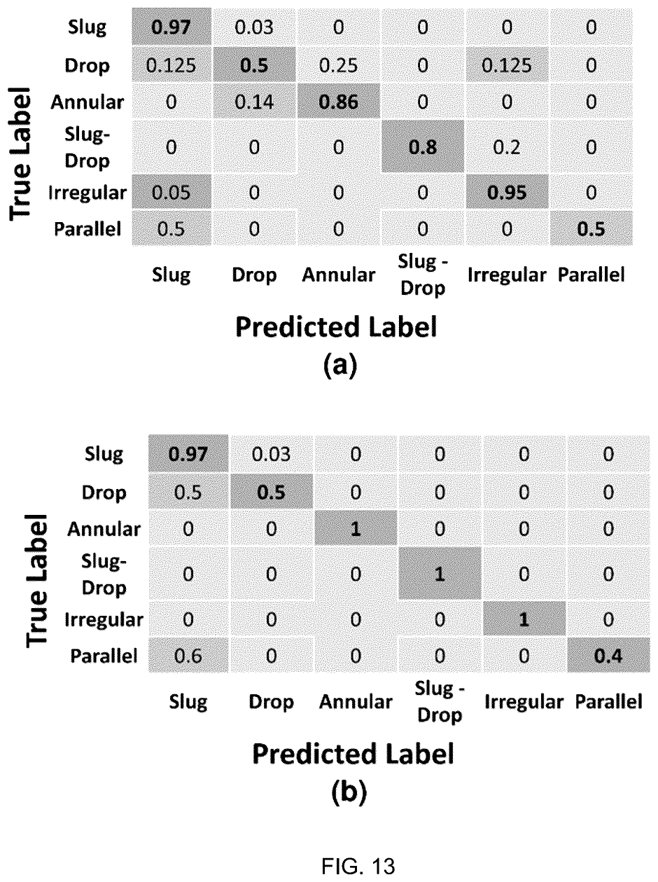

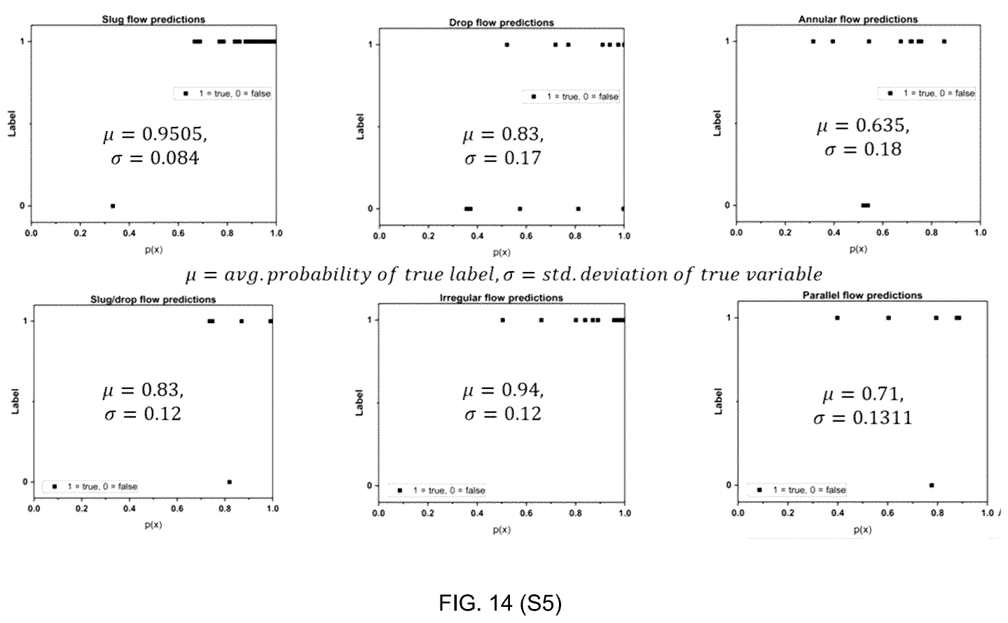

FIG. 13a shows the confusion matrix between the predicted and experimental flow patterns for the random forest model without uncertainty. The model with uncertainty is more predictive (FIG. 13b) for annular, slug-drop, and irregular flow. The prediction probability (FIG. 14) for the slug, slug-drop, and irregular flow is high. In contrast, parallel and annular flow were predicted less accurately due to multiple forces acting simultaneously without a single force being dominant in the transition from one force-dominated regime to another. Overall, both models were more than 85% accurate.

### Impact of Diameter on the Slug Flow

Slug flow has a high degree of internal convection and large specific interfacial area that promote mass and heat transfer. This pattern results from the interplay of interfacial, viscous, and inertial forces. The junction also breaks up the dispersed phase into slugs due to pressure difference between phases.

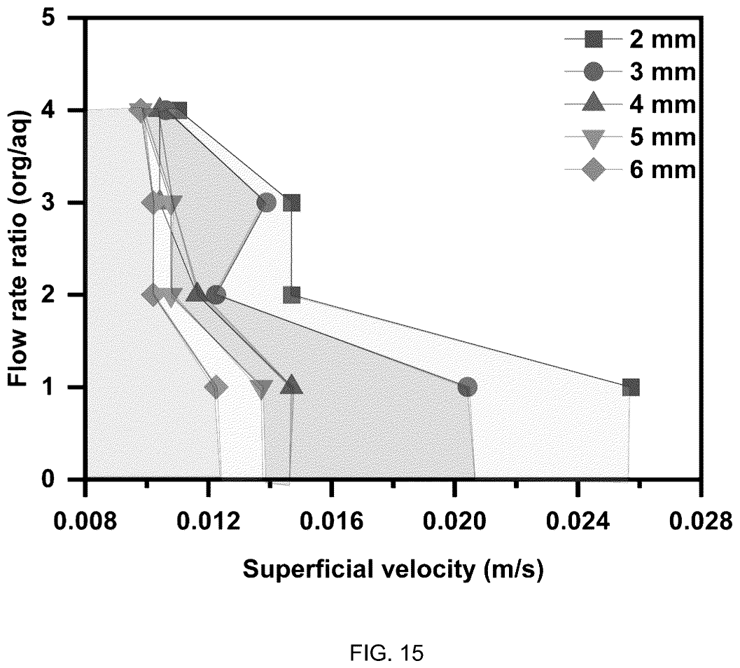

To capture the impact of diameter on the slug flow, we curated a dataset derived from our experiments. We conducted simulations for 5 diameters and flow ratios from one to four. For a fixed diameter and a flow ratio, we incremented the superficial velocity, keeping Re <2100, to generate 400 points (a parametric continuation). The set of diameters, flow ratios, and velocities were then fed to the pretrained Random Forest model to predict the flow pattern. We defined the maximum velocity for a given diameter and flowrate, for which we observed slug flow, as the critical point. These critical velocities are plotted in FIG. 15 (marked points). The x-axis in FIG. 15 shows the superficial velocity in the model and the y-axis the flow rate ratio for this velocity. These results were verified using CFD calculations; slugs were seen at the maximum velocity graphed but not for a velocity 5% higher.

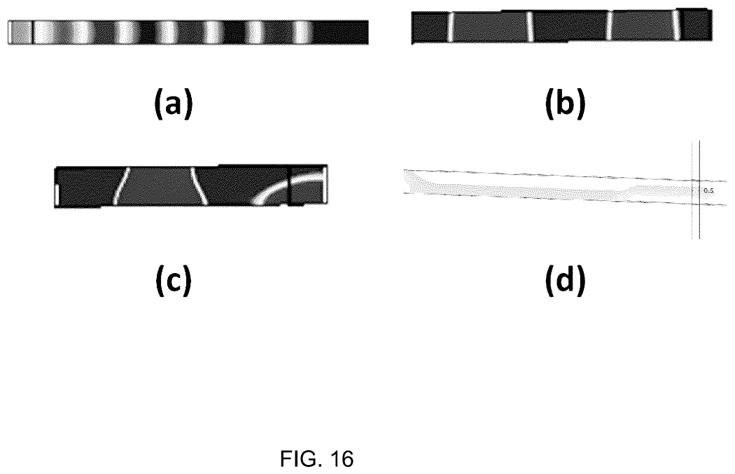

FIG. 15 indicates slug flow even for diameters above 3 mm, despite conventional belief. As the diameter or the flow rate ratio increases, the maximum velocity leading to slug flow decreases. The maximum velocity for slug flow above 4 mm is very low. CFD indicates that the slug flow at larger diameters (>4 mm) happens because of the aqueous flow blocking the junction and then breaking into slugs. As the diameter increases, a trade-off between a higher throughput and slug flow benefits (i.e. higher mass transfer and heat transfer rates) occurs. An interesting feature is symmetry breaking in the transition to no slugs. As the diameter increases, the Bo number increases, and hence, the impact of gravity on the slug over the interfacial force increases. The slug slowly starts deforming and gets attracted to the wall, breaking the symmetry. Results for different diameters for EtAc and water are shown in FIG. 16. FIG. 16c shows visible deformation in a 5 mm diameter microchannel and FIG. 16a depicts a symmetric slug for 0.5 mm diameter.

No significant symmetry changes were observed for drop and annular patterns with increasing diameter, but the parallel flow becomes prominent. A new flow pattern occurs in the transition from parallel flow to annular, which fluctuates between the parallel and annular flow, with the organic phase touching the wall but after some time flowing in between the aqueous flow. This new flow pattern (FIG. 16d) could be rationalized using gravitational and surface forces. The flow converts from parallel to annular flow due to surface forces making the aqueous phase leave the wall and flow inside the organic phase, but the aqueous flow gets attracted toward the other wall due to significant gravity and is converted into the parallel flow again as it flows along the wall. The irregular flow pattern vanishes above 2.4 mm.

### Mass Transfer

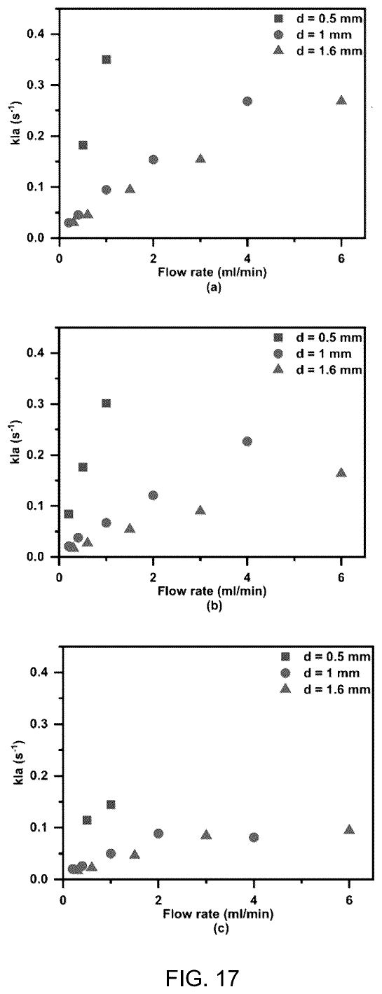

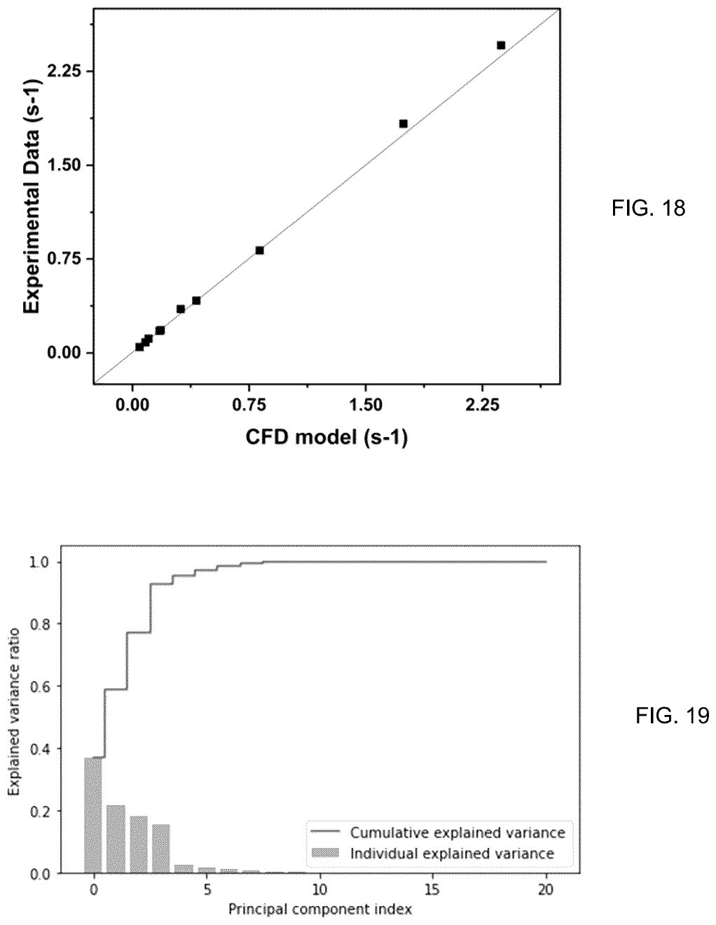

FIG. 17 shows the rate of mass transfer estimated experimentally for the three organic solvents, at a fixed flow ratio of 1:1 as the total flow rate increases from 0.1 to 6 ml/min. The rate of mass transfer decreases with increasing diameter and increases with increasing velocity. Without being held to any particular theory, we postulate that the mass transfer highly depends on the organic solvent properties, such as interfacial tension, viscosity, and density. Experiments for EtAc, d=0.5 mm, L=17 cm, and Q ranging from 0.2 to 5 ml/min were simulated. FIG. 18 shows the parity plot between the CFD-predicted and experimentally estimated rate of mass transfer. The maximum error is 5%. CFD was also used to study the concentration profile along the length (more information is provided in the SI, herein below).

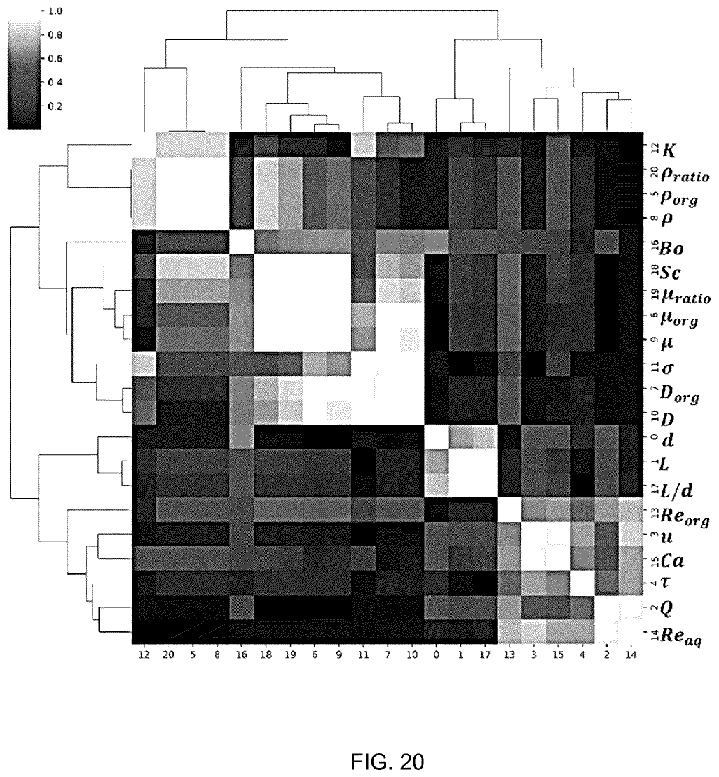

PCA suggests four features to represent the mass transfer rate (FIG. 19). FIG. 20 shows the clustered covariance matrix for the mass transfer rate features; four groups of interdependent features formed, and one feature from each group was chosen. The selected features include the residence time (τ), Capillary number (Ca), Schmidt number over the partition coefficient

$$( \frac{Sc}{K} ) ,$$

and the length over the diameter

$$( \frac{L}{d} ) .$$

Ca and τ belong to the same covariance group but were chosen because Sc & K were combined into one feature.

Using symbolic genetic regression and the above groups, Eq. 7 was discovered to predict the rate of mass transfer. Eq 7 relates the logarithm of Da′ to the logarithm of Ca,

$$\frac{L}{d} , and \frac{Sc}{K}$$

with α, β, γ, and δ as regression constants.

$$\frac{Sc}{K} , \frac{L}{d} ,$$

and Ca capture the solvent properties, geometry of the system, and flow properties, respectively. Eq. 7 supports the hypothesis that the exponents in the power law model depend on solvent properties.

$$log ( {Da}^{′} ) = \frac{α * log ( \frac{S c}{K} ) - β - δ log ( \frac{L}{d} )}{log ( Ca ) + γ} \qquad ( 7 )$$

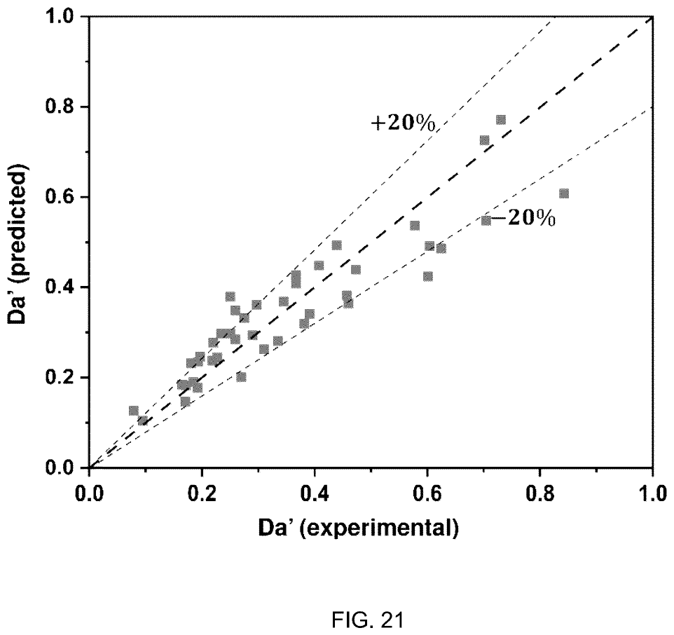

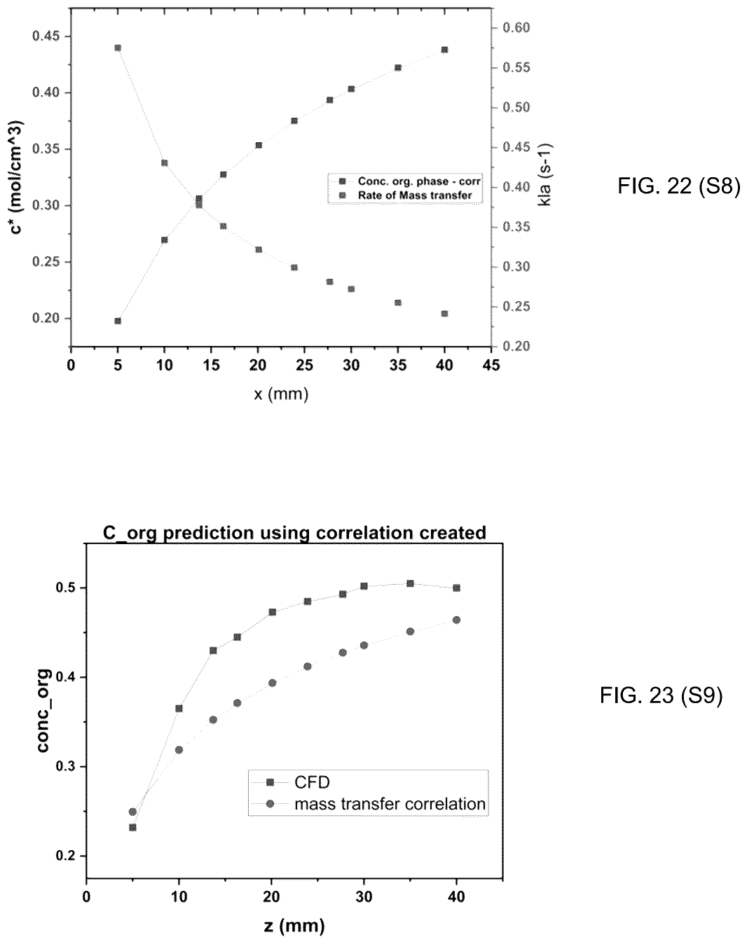

The constants were calculated using the dual annealing minimization technique (but the invention is not limited to any particular optimization method). See, e.g., Ansari et al., supra and Chaabene et al, supra. The normalized error between the actual and predicted rate of mass transfer was used as the cost function. The final form is Eq. 8. The parity plot between the predicted and experimental data is shown in FIG. 21. The maximum deviation was 20%, and the average error was 13%.

$$log ( {Da}^{′} ) = \frac{1.38 * log ( \frac{S c}{K} ) - 0.972 - 0.84 * log ( \frac{L}{d} )}{log ( Ca ) + 0.525} \qquad ( 8 )$$

When Ca<<1, the denominator is negative. As the velocity increases, τ decreases and Ca increases. However, τ affects k_{L}α more and the rate of mass transfer increases. Similarly, as the length of the microchannel increases, the rate of mass transfer decreases due to significant increase in τ. With increasing diameter, the leading coefficient becomes negative, leading to decreasing mass transfer. The solvent properties (Table 2) have a significant impact: as the diffusivity, density, or partition coefficient increase, the rate of mass transport increases. The opposite happens with the viscosity (i.e. as viscosity increases, the rate of mass transport decreases).

The proposed model can be used to predict the rate of mass transfer and the concentration of the solute in the organic solvent, as shown in FIG. 23. The predicted and CFD concentrations differ near the T-junction that enhances mixing. Upon formation of a stable flow pattern, the difference gradually decreases. Hence, the proposed model predicts accurately the concentration away from the junction.

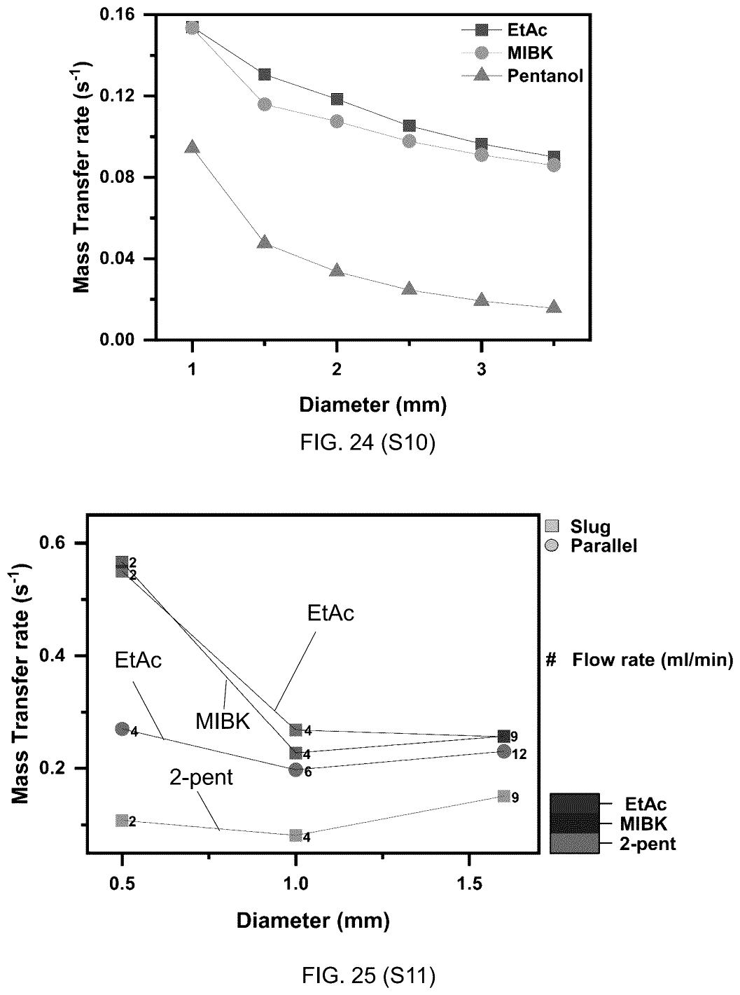

Scaling up from micro to milli scale is advantageous, as it decreases the capital cost and can increase the throughput. FIG. 24 shows that organic solvents with lower Sc/K values (such as EtAc) exhibit higher mass transfer rates (predicted using Eq. 8) that can counterbalance the effect of increasing diameter, resulting in a slight reduction of mass transfer rate. Notably, as the diameter increases, the percentage decrease in the mass transfer rate due to the flow pattern change from slug to parallel diminishes. For example, FIG. 25 indicates a ˜50%, 26.4%, and 10% decrease when changing from slug to parallel flow for 0.5 mm, 1 mm, and 1.6 mm, respectively, using an EtAc to aqueous ratio of 1:1 based on our CFD simulations. This decrease can be compensated by increasing the velocity and using alternative flow patterns, such as the irregular flow pattern, which shows higher mass transfer rate than the slug flow pattern. The predictive flow pattern and mass transfer models may be used to guide design.

Uncertainty propagation was used to estimate the accuracy of the proposed correlation. See, e.g., Chen, W.; Cohen, M.; Yu, K.; Wang, H.-L.; Zheng, W.; Vlachos, D. G., “Experimental data-driven reaction network identification and uncertainty quantification of CO2-assisted ethane dehydrogenation over Ga2O3/Al2O3.” Chemical Engineering Science, 2021, 237, 116534; Feng, J.; Lansford, J. L.; Katsoulakis, M. A.; Vlachos, D. G., “Explainable and trustworthy artificial intelligence for correctable modeling in chemical sciences.” Science Advances 2020, 6 (42), eabc3204. The HMF concentration in the organic phase shows an 4.8% standard deviation (s.d.), leading to a partition coefficient s.d. of 4%. See, Li, G.; Shang, M.; Song, Y.; Su, Y. Characterization of liquid-liquid mass transfer performance in a capillary microreactor system. AIChE Journal 2018, 64 (3), 1106-1116. DOI: 10.1002/aic. 15973 (acccessed 2022 Apr. 25/16:54:38); Li, G.; Pu, X.; Shang, M.; Zha, L.; Su, Y., “Intensification of liquid-liquid two-phase mass transfer in a capillary microreactor system.” AIChE Journal 2019, 65 (1), 334-346. Uncertainty in the velocity results in uncertainty in the flow rate ratio

$$( 4 \% s . d , u ∼ N ( {μ}_{u} , 0.04 ) \to \frac{{u}_{a q}}{{u}_{org}} ∼ N ( {μ}_{r a t i o} , 0.04 ) ) .$$

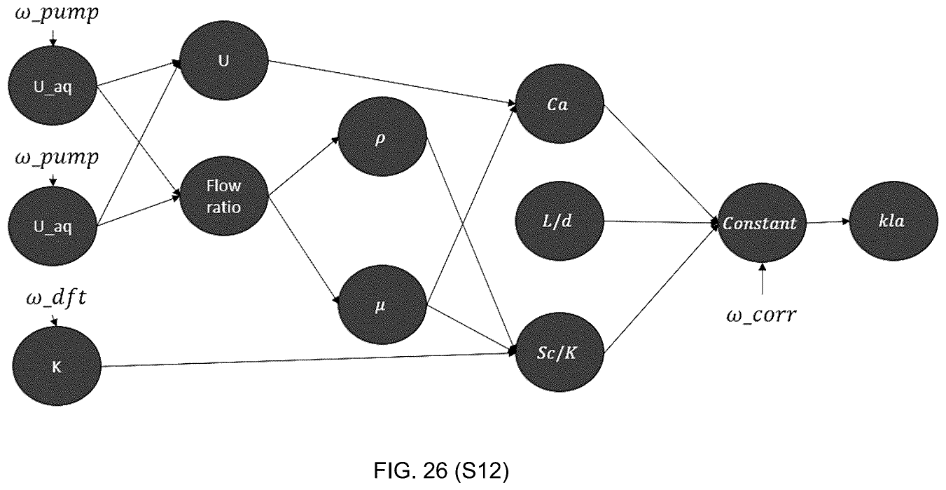

As these are key variables in Eq. 6, propagation of uncertainty was calculated. FIG. 26 shows the workflow to calculate the uncertainty in the rate of mass transfer. After introducing uncertainty in the velocity and partition coefficient, 2,000 points were sampled from a normal distribution. This was repeated for the entire data set, and the parameters of the correlation were calculated in each iteration using the dual annealing method. These constants were inputted in a Gaussian inference algorithm and fitted with a normal distribution. The uncertainty in the rate of mass transfer was calculated to be >50%.

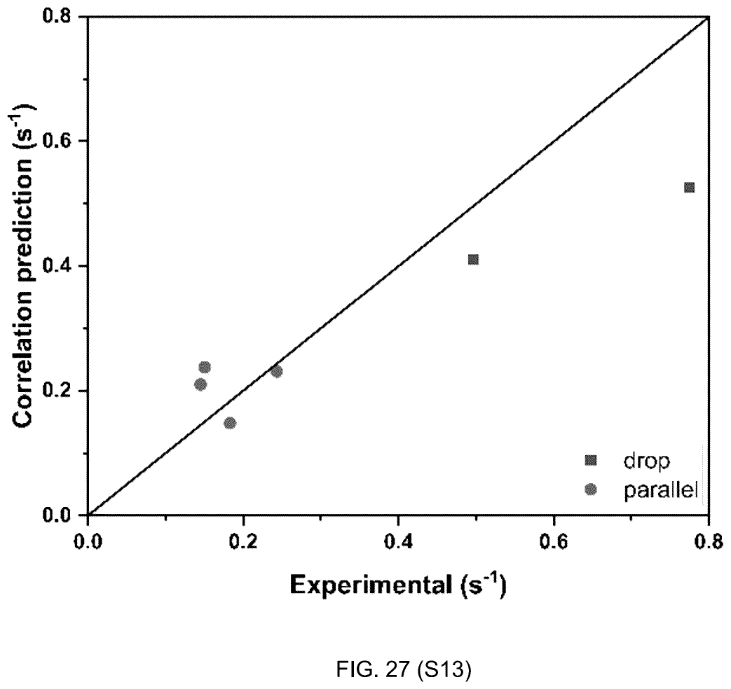

As the data used to create the correlation was in the slug flow, we checked its applicability to other flow patterns. Mass transfer experiments in drop and parallel flow match well the model, as shown in FIG. 27. Higher underprediction occurs for the drop flow probably due to the high specific area compared to slug flow. The correlation may be further improved by increasing the size of the data set including other flow patterns.

### CONCLUSIONS

In this study, flow patterns in liquid-liquid microchannels were examined across various diameters and organic solvents using both experimental methods and CFD simulations within a T-junction system. The flow pattern data was augmented using mined experimental data from the literature. The heterogeneous data was employed to create a random forest model of predicting flow patterns. Six (6) flow patterns were seen, namely slug, parallel, drop, slug/drop, annular, and irregular.

The random forest model demonstrates accurate prediction capabilities for all flow patterns, except for regions near transition points. With an increase in diameter, gravitational forces influence the dispersed phase, leading to deformations along the slug flow interface. Parallel and droplet flows experience minimal gravity-induced impact, while new annular flow patterns emerge. Irregular flow patterns cease to occur above a 2.4 mm diameter at Re<2000.

A mass transfer correlation was established using experimental data and symbolic genetic regression. The rapid mixing at the junction promotes substantial transfer of HMF from the aqueous to the organic phase. This correlation effectively predicts mass transfer rates using dimensionless numbers such as Ca, Sc/K, and L/d. The correlation aligns with anticipated trends concerning the impact of velocity and diameter, and it also reveals, for the first time, the influence of solvent properties. The primary source of uncertainty in the mass transfer correlation lies in the correlation constants. The enhancement of the correlation may be achieved through the inclusion of additional data spanning other flow patterns.

### Supplementary Information (SI)

### Flow Pattern Definitions

Slug flow: In this flow regime, depicted in FIG. 10A, the slugs of both phases have a length greater than the diameter. We see this flow pattern at relatively low flow rates. Slug is usually formed because of dripping, jetting, and threading.
Drop flow: In this flow regime, depicted in FIG. 10B, the water flows as drops in the organic phase. Drops sizes are comparable to the diameter.
Slug/Drop: This flow regime, depicted in FIG. 10C, consists of alternating slugs and droplets which are non-uniform in size.
Annular flow: In this flow regime, depicted in FIG. 10D, the aqueous layer flows between the organic solvent.
Parallel flow: In this flow regimedepicted in FIG. 10E, the aqueous layer flows in parallel to the organic solvent.
Irregular flow: In this flow regime, depicted in FIG. 10F, the dispersed aqueous phase has varying size.

### Dimensionless Numbers

$$R e = \frac{ρ uD}{μ} = Interfacial forces / viscous forces \qquad [ S 1 ]$$

$$Ca = \frac{μ u}{σ} = Viscous forces / surface forces \qquad [ S2 ]$$

$$We = \frac{ρ {u}^{2} D}{σ} = Intertial forces / Surface forces \qquad [ S3 ]$$

$$Oh = \frac{μ}{\sqrt{ρσ D}} = Viscous forces / \sqrt{Interfacial forces \times Surface forces} \qquad [ S4 ]$$

$$Bo = \frac{( {ρ}_{o r g} - {ρ}_{a q} ) g {D}^{2}}{σ} = gravitational forces / Surface force \qquad [ S5 ]$$

$$Sc = \frac{μ}{ρ D} = viscous diffusion rate / molecular ( mass ) diffusion rate \qquad [ S6 ]$$

Linear regression was performed on individual solvents to find the relation Da′ and diameter. The exponents depend on the solvent.

### Da′ Definition

$$\begin{matrix}Da ’ ( {k}_{l} a τ ) = \frac{D a ( I )}{D a ( I I )} \\ Da ( I ) = r τ = \frac{rate of reaction}{rate of global transport} \\ Da ( II ) = \frac{r}{{k}_{l} a} = \frac{rate of reaction}{rate of global mass transport} \\ Hence , Da ’ ( {k}_{l} a τ ) = \frac{rate of global transport}{rate of global mass transport}\end{matrix}$$

Each element of the confusion matrix represents the fraction of the experimental flow patterns (y-axis) predicted by CFD (x-axis). Diagonal (off-diagonal) elements represent correct (incorrect) predictions. The model is reasonably accurate. Most wrong predictions are related to slug/drop in EtAc and droplet flow in MIBK. Both are related to the contact angle assumption between the fluids and microchannel walls. As the contact angle decreases or increases, the wall becomes hydrophilic or hydrophobic, respectively.

The rate of mass transfer, calculated from the concentration shown in Figure S7, decreases downstream due to decreased driving force; significant mass transfer happens at the junction.

All references as discussed herein above are incorporated herein by reference for all purposes, without limitation.

What is claimed:

1. A method for designing a second liquid-liquid biphasic micro-fluidic flow channel reactor, the method comprising the steps of:
(a) providing a plurality of experimental datasets as a function of an organic solvent and a first inner diameter of a first liquid-liquid biphasic micro-fluidic flow channel reactor, wherein the first liquid-liquid biphasic micro-fluidic flow channel reactor comprises a first inlet channel for a first stream comprising an aqueous phase comprising at least a first compound dispersed in water and a second inlet channel for a second stream comprising an organic phase comprising an organic solvent operative to extract the first compound from the aqueous phase, the first stream and the second stream configured to intersect in a micromixer region connected to an outlet channel for outputting a third stream of biphasic fluid in which a mass percentage of the first compound transfers into the organic solvent;
(b) providing a plurality of computational fluid dynamics (CFD) datasets as a function of the aqueous phase, the organic phase, and an inner diameter of the first liquid-liquid biphasic micro-fluidic flow channel reactor;
(c) developing at least one active machine learning (ML) model to predict biphasic flow patterns and mass transfer rate in the micro-fluidic flow channel, wherein the at least one active ML model uses a training subset of the plurality of experimental datasets and a training subset of the plurality of CFD datasets;
(d) testing the efficacy of the at least one active ML model using a remaining testing subset of the plurality of experimental datasets and a remaining testing subset of the plurality of CFD datasets not used for development of the at least one active ML model;
(e) generating a mathematical expression for determining a predicted maximum mass transfer rate as a function of inner diameter and length of the outlet channel, using the at least one active ML model;
(f) designing a second liquid-liquid biphasic micro-fluidic flow channel reactor, having the same micromixer configuration and the same organic and aqueous phases as that of the first liquid-liquid biphasic micro-fluidic flow channel reactor, using the mathematical expression generated in step (e), wherein a second inner diameter of the second liquid-liquid biphasic micro-fluidic flow channel reactor is greater than the first inner diameter, whereby a second throughput of the second liquid-liquid biphasic micro-fluidic flow channel reactor is greater than a first throughput of the first liquid-liquid biphasic micro-fluidic flow channel reactor.

2. The method according to claim 1, wherein the organic phase further comprises a second compound dispersed in the organic solvent, and wherein the biphasic fluid comprises a third compound which is a product of a reaction between the first compound and the second compound.

3. The method according to claim 1, wherein the step of providing the plurality of CFD datasets comprises performing principal component analysis (PCA) to identify features, including material properties and dimensionless parameters, for both the aqueous phase and the organic phase that has an impact on the liquid-liquid biphasic micro-fluidic flow channel reactor's behavior.

4. The method according to claim 3, wherein the features for each of the aqueous phase and the organic phase comprises kinematic viscosity (μ), density (φ, velocity (u), Capillary number (Ca), Reynolds number (Re), Weber number (We), Ohnesorge number (Oh), and Diffusivity (D).

5. The method according to claim 1, wherein the step of developing the at least one active ML model comprises using a random forest algorithm to predict biphasic flow patterns.

6. The method according to claim 5, wherein the biphasic flow patterns are selected from the group consisting of a slug flow, a drop flow, a slug/drop flow, and an irregular flow.

7. The method according to claim 6, wherein a response space of the at least one ML model encompasses the predicted biphasic flow patterns and predictors comprising features that represent the biphasic flow patterns for each of the aqueous phase and the organic phase.

8. The method according to claim 7, further comprising performing principal component analysis (PCA) to determine features to represent the mass transfer rate, wherein the features comprise Capillary number (Ca), Schmidt number over the partition coefficient (Sc/K), and the length over the diameter (L/d).

9. The method according to claim 8, wherein the step of developing the at least one active ML model further comprises using symbolic genetic regression to develop a new functional form of mass transfer using the features identified by PCA to represent mass transfer rate.

10. The method according to claim 1, wherein the second liquid-liquid biphasic micro-fluidic flow channel reactor comprises at least one millimeter-sized fluidic flow channel.

11. The method according to claim 1, wherein the aqueous phase comprises 5-hydroxymethylfurfural (HMF) as the first compound.

12. The method according to claim 11, wherein the organic solvent comprises ethyl acetate, 2-pentanol, methyl isobutyl ketone, or a combination thereof.

13. The method according to claim 11, wherein the first and the second liquid-liquid biphasic micro-fluidic flow channel reactor have the micromixer configuration of a T-junction.

14. The method according to claim 11, wherein the biphasic fluid pattern is slug flow.

15. The method according to claim 14, further comprising using symbolic genetic regression to define the mathematical expression as equation (1):
$$log ( {Da}^{′} ) = \frac{α * log ( \frac{S c}{K} ) - β - δ log ( \frac{L}{d} )}{log ( Ca ) + γ} \qquad ( 1 )$$
wherein:
$${Da}^{′} ( {k}_{l} a τ ) = \frac{rate of global transport}{rate of global mass transport} ,$$
Ca is a Capillary number; Ca=μ_{org}u_{aq}/σ, where μ_{org} is a dynamic viscosity of the organic phase, u_{aq} is the velocity of the aqueous phase, and σ is interfacial tension between the organic and aqueous phase,
Sc=μ/ρD=viscous diffusion rate/molecular (mass) diffusion rate, where μ, ρ, and D are the dynamic viscosity, density, and diffusivity,
K is partition coefficient of the first compound in the biphasic fluid,
L is a length and d is an inner diameter of the outlet channel, and
α, β, γ, and δ are regression constants.

16. The method according to claim 15, wherein the α, β, γ, and δ are determined from regressing to experimental data, computational data, or a combination thereof.

17. The method according to claim 11, wherein the aqueous phase comprises (i) fructose and/or glucose and a Brønsted acid-catalyst used for dehydration of fructose and/or glucose to yield the HMF, or (ii) glucose and Lewis and Bronsted acid catalysts for isomerization and dehydration reaction to yield the HMF.

18. The method according to claim 11, wherein the method further comprises heating of the biphasic fluid in the outlet channel.

19. The method of claim 18, wherein the heating step comprises microwave heating.

20. The method of claim 1, wherein the first stream comprises a product stream and/or a waste stream, wherein the product stream comprises biomass known as a feedstock for production of renewable fuels, chemicals, bioplastics, or combination thereof, and the waste stream comprises food waste, agricultural waste, forestry waste, or a combination thereof.

21. A liquid-liquid biphasic micro-fluidic flow channel reactor comprising a first inlet channel configured to receive a stream of an aqueous phase comprising 5-hydroxymethylfurfural (HMF) and a second inlet channel configured to receive a stream of an organic solvent for extracting HMF from the aqueous phase, the organic solvent selected from the group consisting of: ethyl acetate, 2-pentanol, methyl isobutyl ketone, and a combination thereof, the first inlet channel and second inlet channel intersecting in a micromixer region connected to an outlet channel configured to receive a stream of biphasic fluid comprising the HMF in the aqueous phase and the organic solvent, the reactor configured in conformance with mathematical expression (1):
$$log ( {Da}^{′} ) = \frac{α * log ( \frac{S c}{K} ) - β - δ log ( \frac{L}{d} )}{log ( Ca ) + γ} \qquad ( 1 )$$
wherein:
$${Da}^{′} ( {k}_{l} a τ ) = \frac{rate of global transport}{rate of global mass transport} ,$$
Ca is a Capillary number; Ca=μ_{org}u_{aq}/σ, where μ_{org} is a dynamic viscosity of the organic phase, u_{aq} is the velocity of the aqueous phase, and σ is interfacial tension between the organic and aqueous phase,
Sc=μ/ρD=viscous diffusion rate/molecular (mass) diffusion rate, where μ, ρ, and D are the dynamic viscosity, density, and diffusivity,
K is partition coefficient of the first compound in the biphasic fluid,
L is a length and d is an inner diameter of the outlet channel, and
α, β, γ, and δ are regression constants.

22. The liquid-liquid biphasic micro-fluidic flow channel reactor according to claim 21,
wherein the micromixer has a configuration of a T-junction.

23. The liquid-liquid biphasic micro-fluidic flow channel reactor according to claim 21, wherein the α is in a range of 0.5-20, β is in a range of 0.1-10, γ is in a range of 0.1-10, and δ is in a range of 0.1-5.

24. The liquid-liquid biphasic micro-fluidic flow channel reactor according to claim 21, wherein the biphasic fluid has slug flow pattern.

25. The liquid-liquid biphasic micro-fluidic flow channel reactor of claim 21, wherein the aqueous phase further comprises (i) fructose and the liquid-liquid biphasic micro-fluidic flow channel reactor converts the fructose to HMF via a Brønsted acid-catalyzed fructose dehydration or (ii) glucose and the liquid-liquid biphasic micro-fluidic flow channel reactor converts the glucose to HMF via a Lewis and Brønsted acid-catalyzed isomerization and dehydration reaction.

26. The liquid-liquid biphasic micro-fluidic flow channel reactor of claim 21, further comprising a heat source arranged to heat the outlet channel.

27. The liquid-liquid biphasic micro-fluidic flow channel reactor of claim 26, wherein the heat source comprises a microwave chamber configured to direct microwave energy into the outlet channel.
